(19) United States
(12) Patent Application Publication
(10) Pub. No.: US 2023/0086397 A1
(43) Pub. Date: Mar. 23, 2023

(54) METHOD AND APPARATUS FOR REDUCING RODENT NEOPHOBIA WITH RESPECT RODENT TO POPULATION CONTROL MEANS

(71) Applicant: Randy Witten, Nephi, UT (US)

(72) Inventor: Randy Witten, Nephi, UT (US)

(21) Appl. No.: 17/991,514

(22) Filed: Nov. 21, 2022

Related U.S. Application Data
(63) Continuation-in-part of application No. PCT/US2022/030759, filed on May 24, 2022.
(60) Provisional application No. 63/212,087, filed on Jun. 17, 2021.
(60) Provisional application No. 63/192,512, filed on May 24, 2021.

(51) Int. Cl. A01K 13/00; A01M 23/16

(52) U.S. Cl. CPC A01K 13/003; A01M 23/16

(57) ABSTRACT

A pest enticement enclosure (10) reduces stress responses of target pest animals (122) in vicinity to a pest control system (80). The enclosure (10) preserves attractants, bait (162), poison, or contraceptives employed in the pest control system (80) and employs a ventilation system (140) to spread scents of lures (160) well above a ground surface (44).

### CROSS REFERENCE TO RELATED APPLICATION

This application is continuation-in-part of, and claims priority from, International Application No. PCT/US2022/030759, filed on May 24, 2022, which is a non-provisional application of U.S. Provisional Application No. 63/212,087, which was filed on Jun. 17, 2021, and International Application No. PCT/US2022/030759 is a non-provisional application of U.S. Provisional Application No. 63/192,512, which was filed on May 24, 2021, the contents of all of these priority applications are herein incorporated by reference in their entirety for all purposes.

### TECHNICAL FIELD

The field of this disclosure relates generally to methods and devices for appeasing neophobia to population control means and, in particular, to methods and devices to create an environment readily acceptable to rodents.

### BACKGROUND INFORMATION

Pest control methods are commercially available. Some of these methods kill pest animals by mechanical or chemical means. Some of these deadly methods employ a human mechanism while others do not. Some of the deadly methods are environmentally friendly while others are not. Other pest control methods employ contraceptives. These various pest control methods are constantly being improved.

### OVERVIEW OF DISCLOSURE

One aspect of this disclosure relates to reducing stress responses of pest animals in vicinity to a pest control device.

Another aspect of this disclosure relates to reducing the number of pest control devices sufficient for controlling pest populations in a given large area.

In some embodiments, a pest enticement enclosure for a target animal comprises: an outer wall having an interior surface, an exterior surface, an upper end, and a lower rim, wherein the outer wall is configured to be supported above, and spaced apart from, a relative ground surface to form an entry gap between the outer wall and the relative ground surface; a cover configured for connection to the outer wall, wherein the cover and the outer wall are configured to form an interior volume; and a ventilation system configured to draw ambient air through the entry gap into the interior volume and through one or more vents positioned elevationally higher than the lower rim.

In some additional, alternative, or selectively cumulative embodiments, a pest enticement enclosure for a target animal comprises: an outer wall having an interior surface, an exterior surface, and a lower rim; a support system to directly or indirectly support the lower rim of outer wall above, and spaced apart from, a relative ground surface to form an entry gap between the lower rim of outer wall and the relative ground surface; a cover for covering an interior volume within the outer wall, wherein the interior volume has space sufficient to house a pest control system above, and spaced apart from, the relative ground surface; and a ventilation system configured to draw ambient air through the entry gap into the interior volume and through one or more vents positioned elevationally higher than the lower rim.

In some additional, alternative, or selectively cumulative embodiments, a kit for providing a pest enticement enclosure configured for accelerating acclimation to a pest control system comprises: an outer wall having an interior surface, an exterior surface, an upper end, and a lower rim, wherein the outer wall is configured to be supported above, and spaced apart from, a relative ground surface to form an entry gap between the outer wall and the relative ground surface; a cover configured for connection to the outer wall, wherein the cover and the outer wall are configured to form an interior volume, and wherein the cover is detachable from the outer wall or the outer wall includes a detachable or openable panel; and a ventilation system configured to draw ambient air through the entry gap into the interior volume and through one or more vents positioned elevationally higher than the lower rim.

In some additional, alternative, or selectively cumulative embodiments, a kit for providing a pest enticement enclosure configured for accelerating acclimation to a pest control system comprises: an outer wall having an interior surface, an exterior surface, and a lower rim; a support system to directly or indirectly support the lower rim of outer wall above, and spaced apart from, a relative ground surface to form an entry gap between the lower rim of outer wall and the relative ground surface; a cover for covering an interior volume within the outer wall, wherein the interior volume has space sufficient to house a pest control system above, and spaced apart from, the relative ground surface; and a ventilation system configured to draw ambient air through the entry gap into the interior volume and through one or more vents positioned elevationally higher than the lower rim.

In some additional, alternative, or selectively cumulative embodiments, a method for accelerating acclimation to a pest control system comprises: providing a pest enticement enclosure so that it is accessible to a target animal, wherein the pest enticement enclosure includes an outer wall having an interior surface, an exterior surface, a lower rim, and an interior volume that has space sufficient to house a pest control system; supporting the lower rim of outer wall so that the lower rim is above, and spaced apart from, a relative ground surface to form an entry gap between the lower rim of outer wall and the relative ground surface; supporting the pest control system and/or a lure in the interior volume so that the pest control system and/or a lure are above, and spaced apart from, the relative ground surface and are optionally at or above an elevation of the lower rim; and employing a cover to cover the pest control system and/or a lure within interior volume.

In some additional, alternative, or selectively cumulative embodiments, a method for accelerating acclimation to a pest control system comprises: providing a pest enticement enclosure having an outer wall having an interior surface, an exterior surface, an upper end, and a lower rim; a cover configured for connection to the outer wall; and a ventilation system, wherein the outer wall is configured to be supported above, and spaced apart from, a relative ground surface to form an entry gap between the outer wall and the relative ground surface, wherein the cover and the outer wall are configured to form an interior volume, wherein the interior volume is configured to house the pest control system, and wherein the ventilation system is configured to draw ambient air through the entry gap into the interior volume and through one or more vents positioned elevationally higher than the lower rim.

In some additional, alternative, or selectively cumulative embodiments, a method for accelerating acclimation to a pest control system comprises: providing a pest enticement enclosure having an outer wall having an interior surface, an exterior surface, an upper end, and a lower rim; a support system configured to directly or indirectly support the lower rim of outer wall above, and spaced apart from, a relative ground surface to form an entry gap between the lower rim of outer wall and the relative ground surface; a cover for covering an interior volume within the outer wall, wherein the interior volume has space sufficient to house a pest control system above, and spaced apart from, the relative ground surface; and the pest control system; placing the pest control system and/or a lure in the interior volume; placing the pest enticement enclosure so that it is accessible to a target animal.

In some additional, alternative, or selectively cumulative embodiments, a method for accelerating acclimation to a pest control system comprises: placing a pest enticement enclosure in an location that is accessible by a target pest animal, wherein the pest enticement enclosure has an outer wall having an interior surface, an exterior surface, an upper end, and a lower rim; a cover configured for connection to the outer wall; and a ventilation system, wherein the outer wall is configured to be supported above, and spaced apart from, a relative ground surface to form an entry gap between the outer wall and the relative ground surface, wherein the cover and the outer wall are configured to form an interior volume, wherein the interior volume is configured to house the pest control system, and wherein the ventilation system is configured to draw ambient air through the entry gap into the interior volume and through one or more vents positioned elevationally higher than the lower rim; inserting a pest control system; and connecting the cover to the outer wall.

In some additional, alternative, or selectively cumulative embodiments, a pest enticement enclosure comprises: an outer wall having an interior surface, an exterior surface, an upper end, and a lower rim that provides a lower rim boundary, wherein the lower rim boundary defines a major cross-sectional area of the enclosure; one more wall supports configured to directly or indirectly support the outer wall such that it is spaced apart from a relative ground surface to form an entry gap, wherein the one or more platform supports have a maximum support cross-sectional area that is less than or equal to 10% of the major cross-sectional area of the enclosure; a cover configured for connection to the outer wall, wherein the cover and the outer wall are configured to form an interior volume; and a ventilation system configured to draw ambient air through the entry gap into the interior volume and through one or more vents positioned elevationally higher than the lower rim.

In some additional, alternative, or selectively cumulative embodiments, a method for controlling a rodent population comprises: supplying a contraceptive; and dispensing one or more of an antibiotic, an antiviral, or an insecticide from a health-related treatment dispenser, wherein the health-related treatment dispenser comprises one or more of a liquid dispenser or a dust dispenser.

In some additional, alternative, or selectively cumulative embodiments, a method for accelerating acclimation of multiple wild rodents to a pest control system, comprises: providing a pest enticement enclosure so that it is accessible to multiple wild rodents, wherein the pest enticement enclosure includes an outer wall having an interior surface, an exterior surface, a lower rim, and an interior volume that has space sufficient to house a pest control system above, and spaced apart from, the relative ground surface, and wherein the pest enticement enclosure includes an enclosure horizontal cross-sectional area defined by the interior surface of the outer wall at a suspension elevation position in proximity to the lower rim such that the suspension elevation position is closer to the lower rim than to the cover; supporting the lower rim of outer wall by employing a support system so that the lower rim is above, and spaced apart from, a relative ground surface to form an entry gap between the lower rim of outer wall and the relative ground surface; employing a suspension system having one or more horizontally positioned support mechanisms with respective horizontally positioned interior suspension surfaces having a cumulative interior suspension horizontal surface area at the suspension elevation position, wherein a majority of the enclosure horizontal cross-sectional area at the suspension elevation is devoid of the cumulative interior suspension surface area of the horizontally positioned interior suspension surfaces; supporting the pest control system and/or a lure in the interior volume so that the pest control system and/or a lure is above, and spaced apart from, the relative ground surface and is optionally at or above an elevation of the lower rim; employing a cover for covering the interior volume within the outer wall; and employing a ventilation system configured to draw ambient air through the entry gap into the interior volume and through one or more vents positioned elevationally higher than the lower rim.

In some additional, alternative, or selectively cumulative embodiments, a pest enticement enclosure for a target animal, wherein the target animal comprises a wild rodent, the pest enticement enclosure comprises: an outer wall having an interior surface, an exterior surface, and a lower rim; a support system to directly or indirectly support the lower rim of outer wall above, and spaced apart from, a relative ground surface to form an entry gap between the lower rim of outer wall and the relative ground surface; a cover for covering an interior volume within the outer wall, wherein the interior volume has space sufficient to house a pest control system above, and spaced apart from, the relative ground surface; an enclosure horizontal cross-sectional area defined by the interior surface of the outer wall at a suspension elevation position in proximity to the lower rim such that the suspension elevation position is closer to the lower rim than to the cover; a suspension system having one or more horizontally positioned support mechanisms with respective horizontally positioned interior suspension surfaces having a cumulative interior suspension horizontal surface area at the suspension elevation position, wherein a majority of the enclosure horizontal cross-sectional area at the suspension elevation is devoid of the cumulative interior suspension surface area of the horizontally positioned interior suspension surfaces; and a ventilation system configured to draw ambient air through the entry gap into the interior volume and through one or more vents positioned elevationally higher than the lower rim.

In some additional, alternative, or selectively cumulative embodiments, a kit for providing a pest enticement enclosure for accelerating rodent acclimation to a pest control system comprises: an outer wall having an interior surface, an exterior surface, and a lower rim; a support system to directly or indirectly support the lower rim of outer wall above, and spaced apart from, a relative ground surface to form an entry gap between the lower rim of outer wall and the relative ground surface; a cover for covering an interior volume within the outer wall, wherein the interior volume has space sufficient to house a pest control system above, and spaced apart from, the relative ground surface; an enclosure horizontal cross-sectional area defined by the interior surface of the outer wall at a suspension elevation position in proximity to the lower rim such that the suspension elevation position is closer to the lower rim than to the cover; a suspension system having one or more horizontally positioned support mechanisms with respective horizontally positioned interior suspension surfaces having a cumulative interior suspension horizontal surface area at the suspension elevation position, wherein a majority of the enclosure horizontal cross-sectional area at the suspension elevation is devoid of the cumulative interior suspension surface area of the horizontally positioned interior suspension surfaces; and a ventilation system configured to draw ambient air through the entry gap into the interior volume and through one or more vents positioned elevationally higher than the lower rim.

In some additional, alternative, or selectively cumulative embodiments, the pest enticement enclosure comprises: an outer wall having an interior surface, an exterior surface, and a lower rim; a support system to directly or indirectly support the lower rim of outer wall above, and spaced apart from, a relative ground surface to form an entry gap between the lower rim of outer wall and the relative ground surface; a cover for covering an interior volume within the outer wall, wherein the interior volume has space sufficient to house a pest control system above, and spaced apart from, the relative ground surface; a central leg or pedestal for directly or indirectly supporting the outer wall, the pest control system, or the cover; and a ventilation system configured to draw ambient air through the entry gap into the interior volume and through one or more vents positioned elevationally higher than the lower rim.

In some additional, alternative, or selectively cumulative embodiments, a kit for providing a pest enticement enclosure for accelerating rodent acclimation to a pest control system comprises: an outer wall having an interior surface, an exterior surface, and a lower rim; a support system to directly or indirectly support the lower rim of outer wall above, and spaced apart from, a relative ground surface to form an entry gap between the lower rim of outer wall and the relative ground surface; a cover for covering an interior volume within the outer wall, wherein the interior volume has space sufficient to house a pest control system above, and spaced apart from, the relative ground surface; a central leg or pedestal for directly or indirectly supporting the outer wall, the pest control system, or the cover; and a ventilation system configured to draw ambient air through the entry gap into the interior volume and through one or more vents positioned elevationally higher than the lower rim.

In some additional, alternative, or selectively cumulative embodiments, a method for accelerating acclimation of multiple wild rodents to a pest control system comprises: providing a pest enticement enclosure so that it is accessible to multiple wild rodents, wherein the pest enticement enclosure includes an outer wall having an interior surface, an exterior surface, a lower rim, and an interior volume that has space sufficient to house a pest control system above, and spaced apart from, the relative ground surface; supporting the lower rim of outer wall by employing a support system so that the lower rim is above, and spaced apart from, a relative ground surface to form an entry gap between the lower rim of outer wall and the relative ground surface; employing a central leg or pedestal for directly or indirectly supporting the outer wall, the pest control system, or the cover; supporting the pest control system and/or a lure in the interior volume so that the pest control system and/or a lure is above, and spaced apart from, the relative ground surface and is optionally at or above an elevation of the lower rim; employing a cover for covering the interior volume within the outer wall; and employing a ventilation system configured to draw ambient air through the entry gap into the interior volume and through one or more vents positioned elevationally higher than the lower rim.

In some additional, alternative, or selectively cumulative embodiments, the support system is configured to maintain the outer wall in a stationary position, wherein the entry gap comprises a gap entry height that is less than or equal to 2.5 inches (6.35 cm), and wherein the entry gap provides horizontal sight lines from any entry point beneath the lower rim through greater than or equal to 70% of a perimeter of the lower rim.

In some additional, alternative, or selectively cumulative embodiments, the one or more of the lure, the pest control system, or other an internal feature is supported by the suspension system.

In some additional, alternative, or selectively cumulative embodiments, the cover comprises an upper exterior surface and a secondary outer wall, wherein the upper exterior surface is configured for attachment to the secondary outer wall, and wherein the secondary outer wall is configured for attachment to the outer wall.

In some additional, alternative, or selectively cumulative embodiments, the cover comprises an upper exterior surface, and wherein the upper exterior surface is configured for attachment to the outer wall.

In some additional, alternative, or selectively cumulative embodiments, the cover is detachable from the outer wall.

In some additional, alternative, or selectively cumulative embodiments, the outer wall includes a detachable panel to provide access to the interior volume.

In some additional, alternative, or selectively cumulative embodiments, the cover comprises an upper exterior surface that is configured for attachment to an external auxiliary feature.

In some additional, alternative, or selectively cumulative embodiments, the external auxiliary feature comprises a water feature or a food distribution feature.

In some additional, alternative, or selectively cumulative embodiments, the water feature comprises a bird bath or a fountain.

In some additional, alternative, or selectively cumulative embodiments, the food distribution feature comprises a bird feeder or a squirrel feeder.

In some additional, alternative, or selectively cumulative embodiments, the outer wall comprises a curved cross-sectional profile.

In some additional, alternative, or selectively cumulative embodiments, the outer wall comprises an arcuate cross-sectional profile.

In some additional, alternative, or selectively cumulative embodiments, the outer wall comprises an elliptical cross-sectional profile.

In some additional, alternative, or selectively cumulative embodiments, the outer wall comprises a polygonal cross-sectional profile.

In some additional, alternative, or selectively cumulative embodiments, the outer wall comprises a rectangular cross-sectional profile.

In some additional, alternative, or selectively cumulative embodiments, the outer wall comprises a square cross-sectional profile.

In some additional, alternative, or selectively cumulative embodiments, the outer wall comprises a hexagonal cross-sectional profile.

In some additional, alternative, or selectively cumulative embodiments, the outer wall comprises an octagonal cross-sectional profile.

In some additional, alternative, or selectively cumulative embodiments, the outer wall comprises a cross-sectional profile that is a hybrid of a curved cross-sectional profile and a polygonal cross-sectional profile.

In some additional, alternative, or selectively cumulative embodiments, the cover comprises a secondary outer wall that has a cross-sectional profile that corresponds to a cross-sectional profile of the outer wall.

In some additional, alternative, or selectively cumulative embodiments, the cover comprises a secondary outer wall that has a cross-sectional profile that corresponds to a cross-sectional profile of the outer wall, and wherein a bottom portion of the secondary outer wall is configured to slide over an upper portion of the outer wall.

In some additional, alternative, or selectively cumulative embodiments, the one or more vents are positioned in through the cover.

In some additional, alternative, or selectively cumulative embodiments, the one or more vents are positioned in the secondary outer wall of the cover.

In some additional, alternative, or selectively cumulative embodiments, the one or more vents are positioned in the outer wall.

In some additional, alternative, or selectively cumulative embodiments, the one or more vents comprise spacing between the secondary outer wall and the outer wall.

In some additional, alternative, or selectively cumulative embodiments, the spacing between the secondary outer wall and the outer wall is created by one or more bumps on the exterior surface of the outer wall or one or more bumps on an interior surface of the secondary outer wall.

In some additional, alternative, or selectively cumulative embodiments, the one or more vents comprise spacing between the secondary outer wall and the outer wall.

In some additional, alternative, or selectively cumulative embodiments, the one or more vents have protective flaps.

In some additional, alternative, or selectively cumulative embodiments, the ventilation system employs interior baffles.

In some additional, alternative, or selectively cumulative embodiments, the ventilation system employs a fan.

In some additional, alternative, or selectively cumulative embodiments, the ventilation system is configured to inject attracting scents into a prevailing wind pattern from greater than or equal to 12 inches (30.5 cm) above ground level.

In some additional, alternative, or selectively cumulative embodiments, the ventilation system is configured to inject attracting scents into a prevailing wind pattern from greater than or equal to 18 inches (45 cm) above ground level.

In some additional, alternative, or selectively cumulative embodiments, the ventilation system is configured to inject attracting scents into a prevailing wind pattern from greater than or equal to 20 inches (50.8 cm) above ground level.

In some additional, alternative, or selectively cumulative embodiments, the ventilation system is configured to inject attracting scents into a prevailing wind pattern from greater than or equal to 22 (55.9 cm) inches above ground level.

In some additional, alternative, or selectively cumulative embodiments, the ventilation system is configured to inject attracting scents into a prevailing wind pattern from greater than or equal to 23 (58.4 cm) inches above ground level.

In some additional, alternative, or selectively cumulative embodiments, the ventilation system is configured to provide cooling to an internal auxiliary feature.

In some additional, alternative, or selectively cumulative embodiments, the ventilation system extends the usable hours per day for the pest control device.

In some additional, alternative, or selectively cumulative embodiments, the internal auxiliary feature comprises one or more of bait, attractant, poison, treatment, and contraceptive.

In some additional, alternative, or selectively cumulative embodiments, the outer wall is supported by one or more legs to form the entry gap.

In some additional, alternative, or selectively cumulative embodiments, the outer wall is configured for attachment to an ambient surface having a substantially vertical orientation.

In some additional, alternative, or selectively cumulative embodiments, the entry gap comprises a gap entry height that is less than or equal to a target animal maximum height plus a buffer height.

In some additional, alternative, or selectively cumulative embodiments, the entry gap comprises a gap entry height that is less than or equal to a target animal maximum height.

In some additional, alternative, or selectively cumulative embodiments, the entry gap comprises a gap entry height that is less than or equal to 95% of a target animal maximum height.

In some additional, alternative, or selectively cumulative embodiments, the entry gap comprises a gap entry height that is less than or equal to 90% of a target animal maximum height.

In some additional, alternative, or selectively cumulative embodiments, the entry gap comprises a gap entry height that is less than or equal to 2.5 inches (6.35 cm).

In some additional, alternative, or selectively cumulative embodiments, the entry gap comprises a gap entry height that is less than or equal to 2.25 inches (5.71 cm).

In some additional, alternative, or selectively cumulative embodiments, the entry gap comprises a gap entry height that is less than or equal to 2 inches (5.08 cm).

In some additional, alternative, or selectively cumulative embodiments, the entry gap comprises a gap entry height that is less than or equal to 1.75 inches (4.45 cm).

In some additional, alternative, or selectively cumulative embodiments, the entry gap comprises a gap entry height that is greater than or equal to 1 inch (2.54 cm).

In some additional, alternative, or selectively cumulative embodiments, the entry gap comprises a gap entry height that is greater than or equal to 1.25 inches (3.18 cm).

In some additional, alternative, or selectively cumulative embodiments, the entry gap comprises a gap entry height that is greater than or equal to 1.5 inches (3.81 cm).

In some additional, alternative, or selectively cumulative embodiments, the entry gap comprises a gap entry height that is greater than or equal to 1.25 inches (3.18 cm).

In some additional, alternative, or selectively cumulative embodiments, the entry gap is continuous around a perimeter of the lower rim.

In some additional, alternative, or selectively cumulative embodiments, the entry gap is substantially continuous around a perimeter of the lower rim.

In some additional, alternative, or selectively cumulative embodiments, the entry gap includes greater than or equal to 95% of a perimeter of the lower rim.

In some additional, alternative, or selectively cumulative embodiments, the entry gap includes greater than or equal to 90% of a perimeter of the lower rim.

In some additional, alternative, or selectively cumulative embodiments, the entry gap includes greater than or equal to 85% of a perimeter of the lower rim.

In some additional, alternative, or selectively cumulative embodiments, the entry gap includes greater than or equal to 80% of a perimeter of the lower rim.

In some additional, alternative, or selectively cumulative embodiments, the entry gap includes greater than or equal to 75% of a perimeter of the lower rim.

In some additional, alternative, or selectively cumulative embodiments, the entry gap provides horizontal sight lines from any entry point beneath the lower rim through greater than or equal to 95% of a perimeter of the lower rim.

In some additional, alternative, or selectively cumulative embodiments, the entry gap provides horizontal sight lines from any entry point beneath the lower rim through greater than or equal to 90% of a perimeter of the lower rim.

In some additional, alternative, or selectively cumulative embodiments, the entry gap provides horizontal sight lines from any entry point beneath the lower rim through greater than or equal to 85% of a perimeter of the lower rim.

In some additional, alternative, or selectively cumulative embodiments, the entry gap provides horizontal sight lines from any entry point beneath the lower rim through greater than or equal to 80% of a perimeter of the lower rim.

In some additional, alternative, or selectively cumulative embodiments, the entry gap provides horizontal sight lines from any entry point beneath the lower rim through greater than or equal to 70% of a perimeter of the lower rim.

In some additional, alternative, or selectively cumulative embodiments, the enclosure comprises an enclosure height between the lower rim and an upper exterior surface of the cover that is less than or equal to 22 inches (55.9 cm).

In some additional, alternative, or selectively cumulative embodiments, the enclosure comprises an enclosure height between the lower rim and an upper exterior surface of the cover that is less than or equal to 20 inches (50.8 cm).

In some additional, alternative, or selectively cumulative embodiments, the enclosure comprises an enclosure height between the lower rim and an upper exterior surface of the cover that is greater than or equal to 12 inches (30.5 cm).

In some additional, alternative, or selectively cumulative embodiments, the enclosure comprises an enclosure height between the lower rim and an upper exterior surface of the cover that is greater than or equal to 14 inches (35.6 cm).

In some additional, alternative, or selectively cumulative embodiments, the enclosure comprises an enclosure height between the lower rim and an upper exterior surface of the cover that is greater than or equal to 16 inches (40.6 cm).

In some additional, alternative, or selectively cumulative embodiments, the pest enticement enclosure is configured for pacifying neophobia of a target animal.

In some additional, alternative, or selectively cumulative embodiments, the target animal is a rodent.

In some additional, alternative, or selectively cumulative embodiments, the target animal is a pest rodent.

In some additional, alternative, or selectively cumulative embodiments, the target animal is a rat.

In some additional, alternative, or selectively cumulative embodiments, the target animal is Rattus norvegicus.

In some additional, alternative, or selectively cumulative embodiments, the target animal is Rattus rattus.

In some additional, alternative, or selectively cumulative embodiments, the target animal is a mouse.

In some additional, alternative, or selectively cumulative embodiments, an attachment mechanism is employed to connect the cover to the outer wall, wherein the attachment mechanism employs a quick-release fastener.

In some additional, alternative, or selectively cumulative embodiments, an attachment mechanism is employed to connect the cover to the outer wall, wherein the attachment mechanism comprises one or more of a clasp, a slot, or a peg.

In some additional, alternative, or selectively cumulative embodiments, the enclosure has an exterior shape of a dome or a beehive.

In some additional, alternative, or selectively cumulative embodiments, the enclosure has an exterior shape of a pyramid.

In some additional, alternative, or selectively cumulative embodiments, the enclosure has an exterior shape of a portion of a sphere.

In some additional, alternative, or selectively cumulative embodiments, the outer wall is configured to support an internal auxiliary feature in the interior volume above the lower rim.

In some additional, alternative, or selectively cumulative embodiments, one or more horizontal support mechanisms are connected to the outer wall or the lower rim to support an internal auxiliary feature in the interior volume above the lower rim.

In some additional, alternative, or selectively cumulative embodiments, one or more of the support mechanisms have a vertical cross-sectional profile that is circular.

In some additional, alternative, or selectively cumulative embodiments, at least one of the support mechanisms comprises a rod or wire.

In some additional, alternative, or selectively cumulative embodiments, one or more of the support mechanisms comprise a suspension strip.

In some additional, alternative, or selectively cumulative embodiments, one or more of the support mechanisms comprise at least two supports that are positioned transverse to each other.

In some additional, alternative, or selectively cumulative embodiments, the enclosure is configured to supply fresh water to encourage the rodents to make return visits to the pest enticement enclosure.

In some additional, alternative, or selectively cumulative embodiments, the enclosure includes a health-related treatment dispenser employing one or more of a liquid dispenser or a dust dispenser to dispense one or more of an antibiotic, an antiviral, or an insecticide.

In some additional, alternative, or selectively cumulative embodiments, the entry gap has a height dimension configured to facilitate entry of medium-sized target animals and to slow entry of larger-sized target animals.

In some additional, alternative, or selectively cumulative embodiments, the pest enticement enclosure has size characteristics that are configured to encourage dwell time within the pest enticement enclosure.

In some additional, alternative, or selectively cumulative embodiments, the pest enticement enclosure is configured to reduce stress behavior of target animals.

In some additional, alternative, or selectively cumulative embodiments, one or more horizontal support rods are connected to the outer wall or the lower rim to support an internal auxiliary feature in the interior volume above the lower rim.

In some additional, alternative, or selectively cumulative embodiments, one or more horizontal support platforms are connected to the outer wall or the lower rim to support an internal auxiliary feature in the interior volume above the lower rim.

In some additional, alternative, or selectively cumulative embodiments, horizontal crossing steel support rods are connected to the outer wall or the lower rim to support an internal auxiliary feature in the interior volume above the lower rim, wherein the steel rods add structural integrity while providing a support structure to anchor the internal auxiliary feature.

In some additional, alternative, or selectively cumulative embodiments, the internal auxiliary feature has a side perimeter that is positioned so that it has a minimum spacing of 2.5 inches (6.35 cm) from greater than or equal to 50% of the nearest points on the interior surface of the outer wall.

In some additional, alternative, or selectively cumulative embodiments, the internal auxiliary feature has a side perimeter that is positioned so that it has a minimum spacing of 3 inches (7.62 cm) from greater than or equal to 50% of the nearest points on the interior surface of the outer wall.

In some additional, alternative, or selectively cumulative embodiments, the internal auxiliary feature has a side perimeter that is positioned so that it has a minimum spacing of 2.5 inches (6.35 cm) from greater than or equal to 75% of the nearest points on the interior surface of the outer wall.

In some additional, alternative, or selectively cumulative embodiments, the internal auxiliary feature has a side perimeter that is positioned so that it has a minimum spacing of 3 inches (7.62 cm) from greater than or equal to 75% of the nearest points on the interior surface of the outer wall.

In some additional, alternative, or selectively cumulative embodiments, the internal auxiliary feature has a side perimeter that is positioned so that it has a minimum spacing of 2.5 inches (6.35 cm) from greater than or equal to 90% of the nearest points on the interior surface of the outer wall.

In some additional, alternative, or selectively cumulative embodiments, the internal auxiliary feature has a side perimeter that is positioned so that it has a minimum spacing of 3 inches (7.62 cm) from greater than or equal to 90% of the nearest points on the interior surface of the outer wall.

In some additional, alternative, or selectively cumulative embodiments, the internal auxiliary feature has a side perimeter that is positioned so that it has a minimum spacing from greater than or equal to 75% of the nearest points on the interior surface of the outer wall to provide one or more of natural upward air flow from around the entire lower rim and obvious easy means of escape.

In some additional, alternative, or selectively cumulative embodiments, the internal auxiliary feature comprises a platform, tunnel, ladder, water dispenser, camera, trap, rodent control device, pest control system, feeding station, or attractant.

In some additional, alternative, or selectively cumulative embodiments, the attractant comprises a food, a food-based scent, or water.

In some additional, alternative, or selectively cumulative embodiments, the enticement enclosure supports an internal auxiliary feature comprising a rodent control system that includes one or more of a live trap, a humane killing device, a poison, treatment, and a contraceptive.

In some additional, alternative, or selectively cumulative embodiments, characteristics of the entry gap and the outer wall cooperate to amplify exterior sound within the interior volume.

In some additional, alternative, or selectively cumulative embodiments, the pest enticement enclosure includes characteristics sufficient to meet EPA requirements for all levels of deployment as a stand-alone bait station.

In some additional, alternative, or selectively cumulative embodiments, the pest control device is commercially available.

In some additional, alternative, or selectively cumulative embodiments, the pest enticement enclosure has size characteristics that are configured to facilitate comfort and inhibit nesting within the pest enticement enclosure.

In some additional, alternative, or selectively cumulative embodiments, the entry gap has a height dimension configured to facilitate entry of medium-sized target animals and to slow entry of larger-sized target animals.

In some additional, alternative, or selectively cumulative embodiments, the pest enticement enclosure has size characteristics that are configured to encourage dwell time within the pest enticement enclosure.

In some additional, alternative, or selectively cumulative embodiments, an internal auxiliary feature comprises a bird feeder.

In some additional, alternative, or selectively cumulative embodiments, an internal auxiliary feature comprises a bird feeder suspended from an underside surface of the cover.

In some additional, alternative, or selectively cumulative embodiments, an internal auxiliary feature comprises a food distribution system configured to limit access to food within the food distribution system.

In some additional, alternative, or selectively cumulative embodiments, an internal auxiliary feature comprises a protected lure.

In some additional, alternative, or selectively cumulative embodiments, an internal auxiliary feature comprises a partly protected lure.

In some additional, alternative, or selectively cumulative embodiments, an internal auxiliary feature comprises a food distribution system configured to promote scattering of food from the food distribution system.

In some additional, alternative, or selectively cumulative embodiments, an internal auxiliary feature comprises a food distribution system including one or more of a bird feeder or a mesh ball.

In some additional, alternative, or selectively cumulative embodiments, one or more of the outer wall, the secondary outer wall, or the cover is insulated.

In some additional, alternative, or selectively cumulative embodiments, the pest enticement enclosure is configured or colored to camouflage with its surrounding.

In some additional, alternative, or selectively cumulative embodiments, the pest enticement enclosure is configured or colored to look like garden art.

In some additional, alternative, or selectively cumulative embodiments, the pest enticement enclosure is configured or colored to be aesthetically pleasing to a human.

In some additional, alternative, or selectively cumulative embodiments, the pest enticement enclosure provides a means for servicing.

In some additional, alternative, or selectively cumulative embodiments, the pest enticement enclosure is configured to provide protection against access by cats, dogs, children under 6 years old, and non-target animals that are larger than rodents.

In some additional, alternative, or selectively cumulative embodiments, the pest enticement enclosure is configured to modify the behavior of target animals.

In some additional, alternative, or selectively cumulative embodiments, the pest enticement enclosure is configured to attract target animals away from undesirable locations.

In some additional, alternative, or selectively cumulative embodiments, the pest enticement enclosure is configured to attract target animals to new more desirable locations and away from less desirable locations.

In some additional, alternative, or selectively cumulative embodiments, the target animal is a rodent, the support system is configured to maintain the outer wall in a stationary position, the entry gap comprises a gap entry height that is less than or equal to 2.5 inches (6.35 cm), and the entry gap provides horizontal sight lines from any entry point beneath the lower rim through greater than or equal to 70% of a perimeter of the lower rim.

In some additional, alternative, or selectively cumulative embodiments, the target animal is a rodent, the support system is configured to maintain the outer wall in a stationary position, the entry gap comprises a gap entry height that is less than or equal to 2.5 inches (6.35 cm), the entry gap provides horizontal sight lines from any entry point beneath the lower rim through greater than or equal to 70% of a perimeter of the lower rim, and the pest control system is supported elevationally at or above the lower rim.

In some additional, alternative, or selectively cumulative embodiments, the target animal is a rodent, the support system is configured to maintain the outer wall in a stationary position, the entry gap comprises a gap entry height that is less than or equal to 2.5 inches (6.35 cm), the entry gap provides horizontal sight lines from any entry point beneath the lower rim through greater than or equal to 70% of a perimeter of the lower rim, and the enclosure comprises an enclosure height between the lower rim and an upper exterior surface of the cover that is greater than or equal to 12 inches (30.5 cm).

In some additional, alternative, or selectively cumulative embodiments, the target animal is a rodent, the support system is configured to maintain the outer wall in a stationary position, the entry gap comprises a gap entry height that is less than or equal to 2.5 inches (6.35 cm), and the entry gap includes greater than or equal to 75% of a perimeter of the lower rim.

In some additional, alternative, or selectively cumulative embodiments, the target animal is a rodent, the support system is configured to maintain the outer wall in a stationary position, the entry gap comprises a gap entry height that is less than or equal to 2.5 inches (6.35 cm), the entry gap includes greater than or equal to 75% of a perimeter of the lower rim, and the pest control system is supported elevationally at or above the lower rim.

In some additional, alternative, or selectively cumulative embodiments, the target animal is a rodent, the support system is configured to maintain the outer wall in a stationary position, the entry gap comprises a gap entry height that is less than or equal to 2.5 inches (6.35 cm), the entry gap includes greater than or equal to 75% of a perimeter of the lower rim, and the enclosure comprises an enclosure height between the lower rim and an upper exterior surface of the cover that is greater than or equal to 12 inches (30.5 cm).

In some additional, alternative, or selectively cumulative embodiments, the lower rim defines a perimeter having a major cross-sectional enclosure dimension, wherein the support system comprises one or more legs, and wherein each leg has major horizontal cross-sectional leg dimension that is less than or equal to 10% of the major cross-sectional enclosure dimension.

In some additional, alternative, or selectively cumulative embodiments, the lower rim defines a perimeter having a major cross-sectional enclosure dimension, wherein the support system comprises one or more legs, and wherein each leg has major horizontal cross-sectional leg dimension that is less than or equal to 5% of the major cross-sectional enclosure dimension.

In some additional, alternative, or selectively cumulative embodiments, the support system comprises the central leg or pedestal.

In some additional, alternative, or selectively cumulative embodiments, the central leg or pedestal directly or indirectly supports the outer wall.

In some additional, alternative, or selectively cumulative embodiments, the central leg or pedestal directly or indirectly supports the pest control system.

In some additional, alternative, or selectively cumulative embodiments, the central leg or pedestal directly or indirectly supports the cover.

In some additional, alternative, or selectively cumulative embodiments, the central leg or pedestal directly or indirectly supports a food-based control mechanism.

In some additional, alternative, or selectively cumulative embodiments, the central leg or pedestal directly or indirectly supports a poison.

In some additional, alternative, or selectively cumulative embodiments, the central leg or pedestal directly or indirectly supports a lure of the pest control system.

In some additional, alternative, or selectively cumulative embodiments, the central leg or pedestal directly or indirectly supports bait of the pest control system.

In some additional, alternative, or selectively cumulative embodiments, the lure is suspended from an interior surface of the cover.

In some additional, alternative, or selectively cumulative embodiments, the lure is suspended from an interior surface of the cover by a hook, a chain, or other attachment mechanism.

In some additional, alternative, or selectively cumulative embodiments, the bait is suspended from an interior surface of the cover by a hook, a chain, or other attachment mechanism.

In some additional, alternative, or selectively cumulative embodiments, an internal auxiliary feature is suspended from an underside surface of the cover.

In some additional, alternative, or selectively cumulative embodiments, the pest enticement enclosure comprises a health-related treatment dispenser.

In some additional, alternative, or selectively cumulative embodiments, the health-related treatment dispenser is configured to dispense one or more of an antibiotic, an antiviral, or an insecticide.

In some additional, alternative, or selectively cumulative embodiments, the health-related treatment dispenser comprises a liquid dispenser.

In some additional, alternative, or selectively cumulative embodiments, the health-related treatment dispenser comprises a dust dispenser.

Selectively cumulative embodiments are embodiments that include any combination of multiple embodiments that are not mutually exclusive.

Additional aspects and advantages will be apparent from the following detailed description of example embodiments, which proceeds with reference to the accompanying drawings.

### BRIEF DESCRIPTION OF THE DRAWINGS

FIG. 1 is a side view of an embodiment of a ground surface-based enticement enclosure having a base pad and showing entry path around an entire rim.

FIG. 2 is a top view of an embodiment of a cover that may form part of, or be connected to, an outer wall of an enticement enclosure.

FIG. 3 is a side view of an alternative embodiment of a ground surface-based embodiment of an enticement enclosure having a top cover and/or over cover with downward sides that is spaced above the outer wall to distribute seeds from an overhanging bird feeder.

FIG. 4 is a side view of an alternative embodiment of a ground surface-based enticement enclosure having a top cover and/or over cover with upward sides that is spaced above the outer wall to function as a bird bath (or seed collection dish if placed under a bird feeder).

FIG. 5 is a side perspective view of an alternative embodiment of a ground surface-based enticement enclosure equipped with a water drip dispenser or water fountain to supply a bird bath-styled top cover and/or over cover.

FIG. 6 is a side perspective view of an alternative embodiment of a ground surface-based enticement enclosure with the top cover and/or over cover removed, showing an upper opening to facilitate ventilation or to accommodate a cover connection mechanism or water supply components.

FIG. 7 is a rear perspective view of an embodiment of a truncated outer wall for a wall-based enticement enclosure to facilitate positioning against, or mounting to, an ambient wall, tree trunk, or other substantially vertical surface.

FIG. 8 is a side view of an embodiment of a wall-based enticement enclosure with a truncated outer wall and a back panel that facilitate mounting to an ambient wall, tree trunk, or other substantially vertical surface.

FIGS. 9 and are side views of alternative embodiments of a wall-based enticement enclosure with a truncated outer wall and a back panel that facilitate positioning near or against, or mounting to, an ambient wall, tree trunk, or other substantially vertical surface.

FIG. 11 is a top and front perspective view of an embodiment of a truncated outer wall and a back panel-platform unit for supporting a pest control system, such as a kill mechanism or poison spaced apart from the ground surface.

FIG. 12 is a top and front perspective view of an embodiment of a truncated outer wall and a back panel-platform unit for supporting a pest control system, such as a food-based control mechanism, spaced apart from the ground surface.

FIG. 13 is a bottom perspective view of an alternative embodiment of a ground surface-based enticement enclosure having an outer wall-support system for supporting the outer wall spaced apart from the ground surface and having a pest-control system-support system for supporting a pest control system, such as a bait box, spaced apart from the ground surface.

FIGS. 14 and 15 are respective bottom and top perspective views of alternative embodiments of a ground surface-based enticement enclosure having an outer wall-support mechanism, such as legs, for supporting the outer wall spaced apart from the ground surface and a suspension system, such as transverse suspension wires, for supporting a pest-control system spaced apart from the ground surface.

FIG. 16 is a front and side perspective view of an alternative embodiment of a pest control system, such as a bait box, spaced apart from the ground surface by legs that have upright extensions configured to support an outer wall and/or a cover.

FIG. 17 is a side view of an alternative embodiment of a ground surface-based enticement enclosure having upright extensions protruding through an interior volume of the enticement enclosure to support a secondary outer wall and/or a cover.

FIG. 18 is a front and side perspective view of an alternative embodiment of a ground surface-based enticement enclosure having geometrically similar side panels to form the outer wall.

FIG. 19 is a top and front perspective view of an alternative embodiment of a ground surface-based enticement enclosure having geometrically similar side panels to form the outer wall, with one of the panels removed to show the interior volume.

FIG. 19A is an embodiment of FIG. 19, showing an alternative embodiment of a pest control system.

FIG. 19B is an embodiment of FIG. 19, showing an alternative embodiment of suspension system.

FIG. 19C is an embodiment of FIG. 19, showing another alternative embodiment of suspension system.

FIG. 20 is a front and side perspective view of another alternative embodiment of a ground surface-based enticement enclosure having geometrically similar side panels to form the outer wall.

FIG. 21 is a top and front perspective view of another alternative embodiment of a ground surface-based enticement enclosure having geometrically similar side panels to form the outer wall, with one of the panels removed to show the interior volume.

FIG. 22 is a top and front perspective view of another alternative embodiment of a ground surface-based enticement enclosure having a dome-like outer wall, with a portion removed to show an alternative suspension system.

FIG. 23 is a top perspective view of another alternative embodiment of a ground surface-based enticement enclosure having geometrically similar side panels to form the outer wall, with the cover removed to show an alternative suspension system.

FIG. 24 is a top and front perspective view of the embodiment of FIG. 23, with the cover removed to show an alternative embodiment of a pest control system.

FIG. 25 is a top perspective view of the embodiment of FIG. 24, with the cover removed to show the alternative embodiment of the pest control system.

FIG. 26 is a cross-sectional side view of another alternative embodiment of a ground surface-based enticement enclosure employing a pedestal to support one or more components of the pest control system or the lure.

FIG. 27 is a cross-sectional side view of an embodiment of a legless ground surface-based enticement enclosure employing a pedestal to support the cover.

### DETAILED DESCRIPTION OF EMBODIMENTS

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” “comprising,” “includes,” “include,” “including,” “have,” “has,” and having” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the exemplary term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Pest control lure, device, and/or method innovations are disclosed herein by way of example to lures, devices, and/or method innovations for addressing nuisance rodent populations, such as murine rodents including rats and mice. However, it will be appreciated that these innovations are not exclusive to murine animals and can be employed for other types of animals, as well as small mammals.

Currently, there are numerous solutions offered for managing rodent populations. Some of these solutions attempt to trap or poison rodents. It is believed that these old solutions fail to meet the needs of the industry because the pest control industry has failed to take advantage of behavioral science findings when designing and deploying conventional devices and methods. Other solutions attempt to use a large number of devices with the knowledge that only some of them will be effective. Still others keep changing the formulations of rodenticides to make them more attractive, while ignoring the deployment realities of rodent behavior. Still others are constantly trying new trap designs that ignore rodent behaviors, and particularly rodent and rat population dynamics that change when the population increases or decreases in size. Nevertheless, these solutions are similarly unable to meet the needs of the industry because they are not utilized properly. These industry standard practices ignore scientific evidence regarding scents, food preferences, and rodent physiology and aggression within family groups. Still, other solutions seek to modify the environment rats live in. These solutions also fail to meet industry needs because there have been no real changes in rodent population control for 50 years, except for the introduction of contraceptives, which are not yet being used to their true potential due to the same problems listed above.

It would be desirable to have lures, devices, and/or methods that make it much easier and cost efficient to control rodent populations with currently used traps, rodenticides, and contraceptives. Rodents and rats, in particular, are very shy and afraid of new objects or conditions in their immediate environment. This “fear of new things” (neophobia) limits the effectiveness and useful locations for using rodent control measures and increases labor and material costs of the industry's current rodent population control measures.

Methods and the features disclosed herein, by virtue of their design and flexible deployment choices, attract and encourage rodents to feel safe when encountering bait, trap, or other pest control system within the enticement enclosures.

It may also be desirable to have a pest management system that lowers costs while able to facilitate multiple pest control methods, such as live traps or contraceptive dispensers, from one installation. It may also be desirable to have a device and method that simplifies and encourages pest control methods that employ no-poison and that employ no-kill methods that avoid harm to non-target wildlife. Moreover, the option to drastically reduce the use of poison rodenticides by using contraceptives protects other wildlife, especially wildlife that preys on the rodents or other target animals. Such a system and device can be used as a success multiplier for conventional apparatus and baits and can be used as an effective, non-poison, population management method for rats and other rodents.

Similarly, an associated method and device may allow locating traps and baits under wild-bird feeders, utilizing the scattered wasted seeds as an attractant to rodent control devices, particularly in urban settings. Such device and method may be complimentary to the practice of feeding wild birds while using conventional extermination methods and devices for pest control.

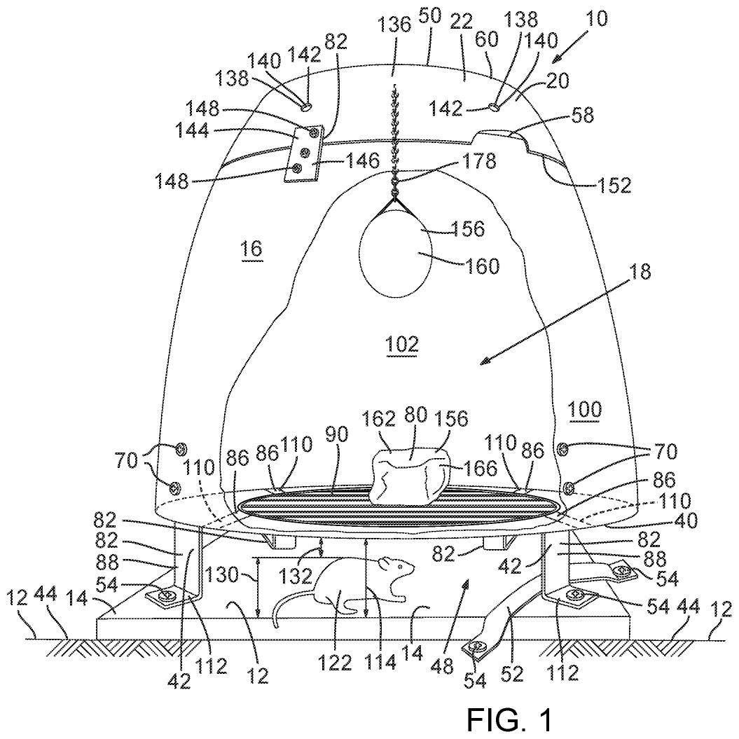

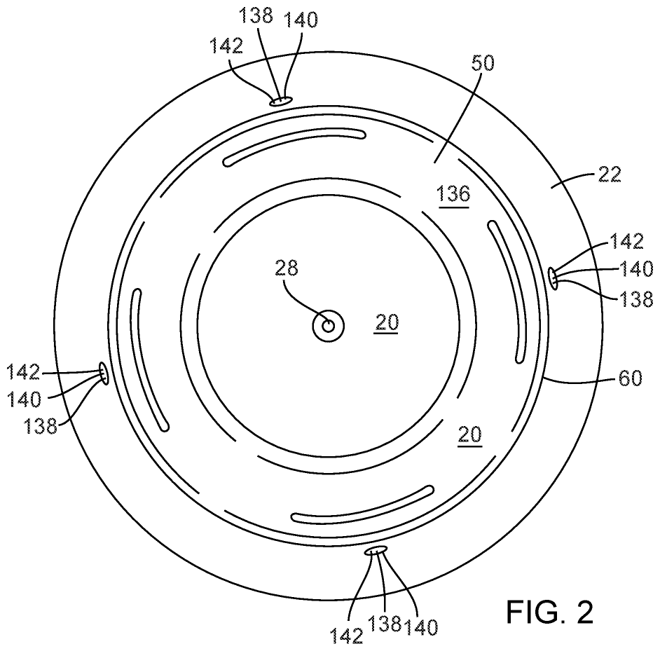

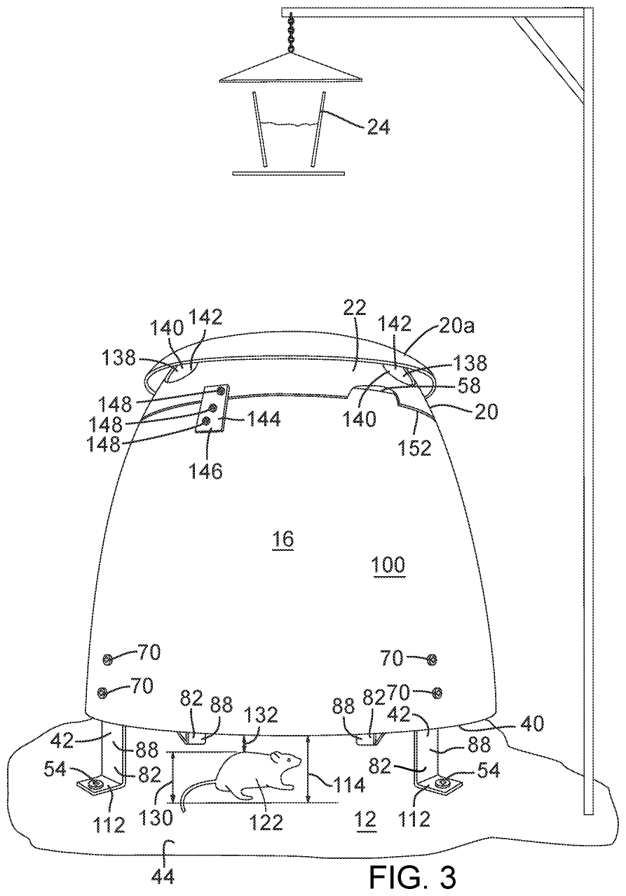

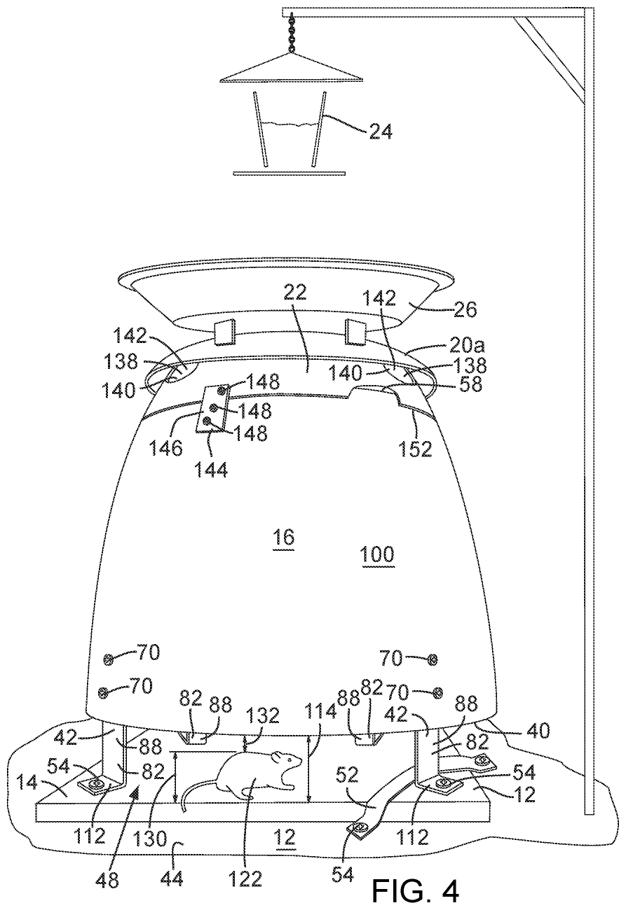

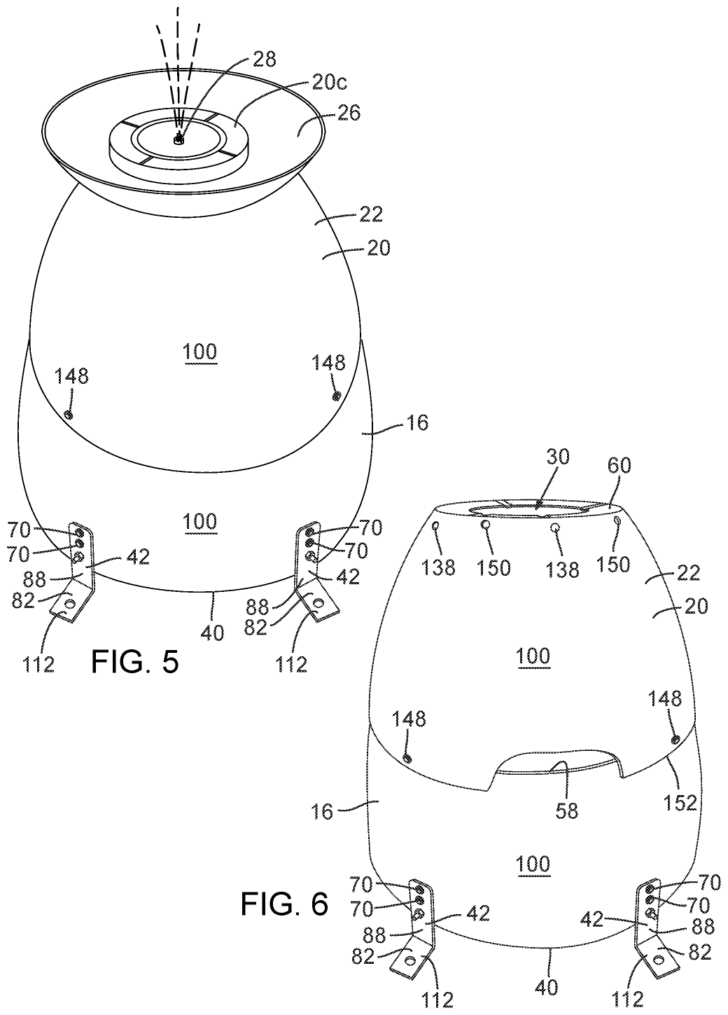

FIG. 1 is a side view of an embodiment of a ground surface-based enticement enclosure 10 supported above a relative ground surface 12 of a base 14 with a portion of an outer wall 16 removed to show an interior volume 18 of the enticement enclosure 10; FIG. 2 is a top view of a roof or cover 20 that may form part of, or be reversibly connectable to, the outer wall 16 of the enticement enclosure 10; FIG. 3 is a side view of an alternative embodiment of a ground surface-based embodiment of an enticement enclosure 10 having an enlarged over cover 20a with an overhanging downward side that may be spaced above the cover 20 and beyond the secondary outer wall 22 to distribute seeds from an overhanging bird feeder 24; FIG. 4 is a side view of an alternative embodiment of a ground surface-based enticement enclosure 10 having an over cover 20b that is spaced above the cover 20 and functions to support a bird bath dish 26 (or seed collection dish if placed under a bird feeder 24); FIG. 5 is a side and top perspective view of an alternative embodiment of a ground surface-based enticement enclosure 10 equipped with a water supply feature 28, such as a water drip dispenser or water fountain to supply a bird bath dish 26 mounted by an over cover 20c; and FIG. 6 is a side and top perspective view of an alternative embodiment of a ground surface-based enticement enclosure 10 with the cover 20 and/or over cover 20c removed, showing an upper opening 30 to facilitate mounting a bird bath dish 26 and/or a water supply feature 28.

With reference to FIGS. 1-6, an enticement enclosure 10 may have a shell or outer wall 16 having a bottom edge or rim 40 that is supported by a support system 42 to be spaced apart from a relative ground surface 12, such as a ground surface 44 or an optional base 14 (or supported by a support system 42 from an ambient wall, tree trunk, or other surface 46 (FIG. 8) having a substantially vertical orientation), to form an entry gap 48 between the lower rim 40 of the outer wall 16 and the relative ground surface 12. The enclosure 10 at its top 50 may also include a cover 20 that may be connectable to, or formed integrally with, the outer wall 16. One or more of the outer wall 16, the secondary outer wall 22, or the cover 20 may be insulated.

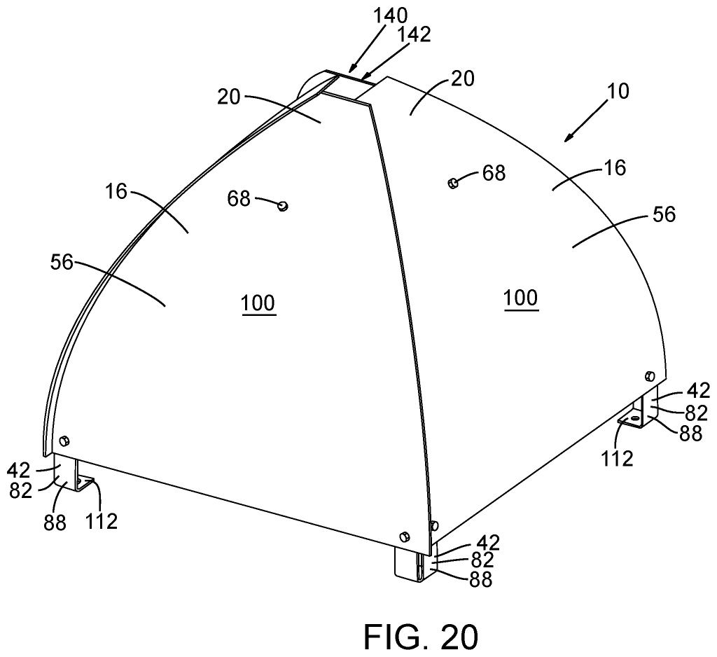

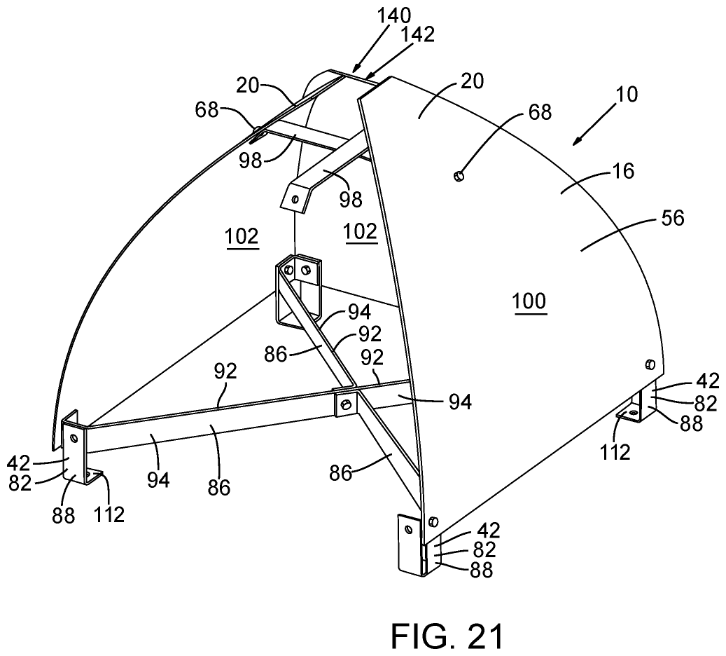

The outer wall 16 and the cover 20 may define an interior volume 18 that they enclose. Moreover, the cover 20 may include any roof-like structure that is protective of the interior volume 18. The cover 20 may provide a substantially continuous exterior surface to not only protect the contents from the weather but also to provide a sense of safety for the target animals 122. In some embodiments, greater than of equal to 90% of the cover area is continuous or greater than 95% of the cover area is continuous. In some embodiments, the cover 20 only partly covers the interior volume 18. For example, the cover 20 may provide for a central opening that may act as a vent 142. Moreover, a collection of wall panels 56 that might form the outer wall 16 and the cover 20 may not reach the center. (See FIGS. 20 and 21.) However, in many embodiments, the cover 20 completely covers the interior volume 18 except for smaller or protected vents 142.

In some embodiments, the enticement enclosure 10 may have an enclosure height 38 between the lower rim 40 and the top 50 of the cover 20 that is greater than or equal to 12 inches (30.5 cm), that is greater than or equal to 14 inches (35.6 cm), or that is greater than or equal to 16 inches (40.6 cm). In some embodiments, the enticement enclosure 10 may additionally or alternatively have an enclosure height 38 that is less than or equal to 22 inches (55.9 cm) or that is less than or equal to 20 inches (50.8 cm).

If the optional base 14 is employed, it may be made from any suitable material, such as organic materials, resins, polymers, plastics, or foams (such as high-density expanded foam), or any combination thereof. In many embodiments, the base material is nonpermeable and washable to the extent that undesirable odors can be removed from the materials with simple washing procedures including but not limited to rinsing or washing with a cleaning agent that does not leave an undesirable scent or residue. Undesirable scents from use by previous animals or from cleaning agents may decrease effectiveness of the enclosure 10. In addition to facilitating improved sanitation, the optional base provides a level surface from which the target animal 122 can access the pest control system 80. A base-securing strap 52 or other base-securing mechanism may be employed, with or without anchors 54 or other fastening agents as later described, to secure the base 14 to a ground surface 44. In some embodiments, the base 14 may have a shallow rim (not shown) so that it can contain a shallow depth of water or powder, either of which can act as a pest control system component such as a lure or contraceptive or as a health or flea treatment as later described. In other embodiments, the base 14 can be unconnected to the enticement enclosure 10 and constitute a shallow tray or pan that the entire enticement enclosure 10 can be set it.

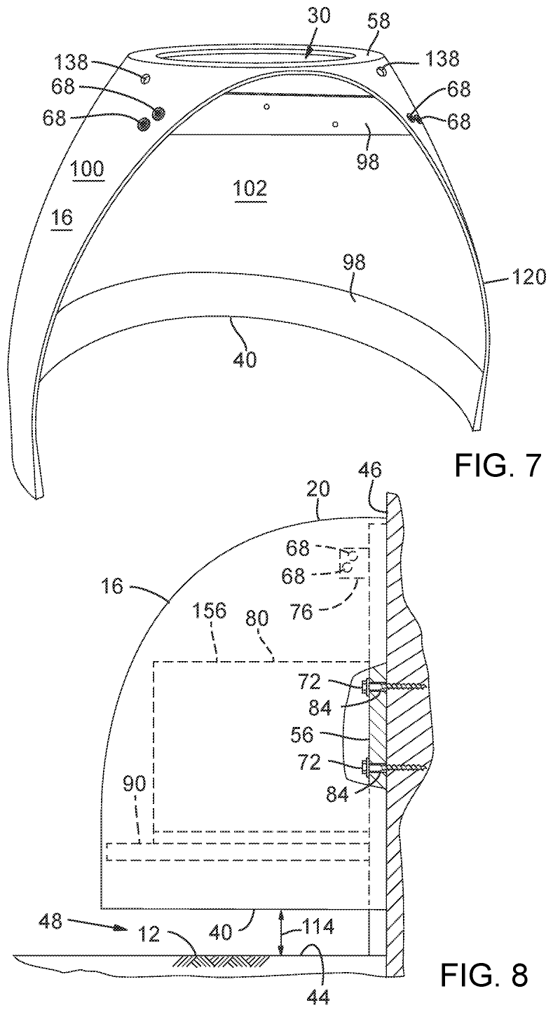

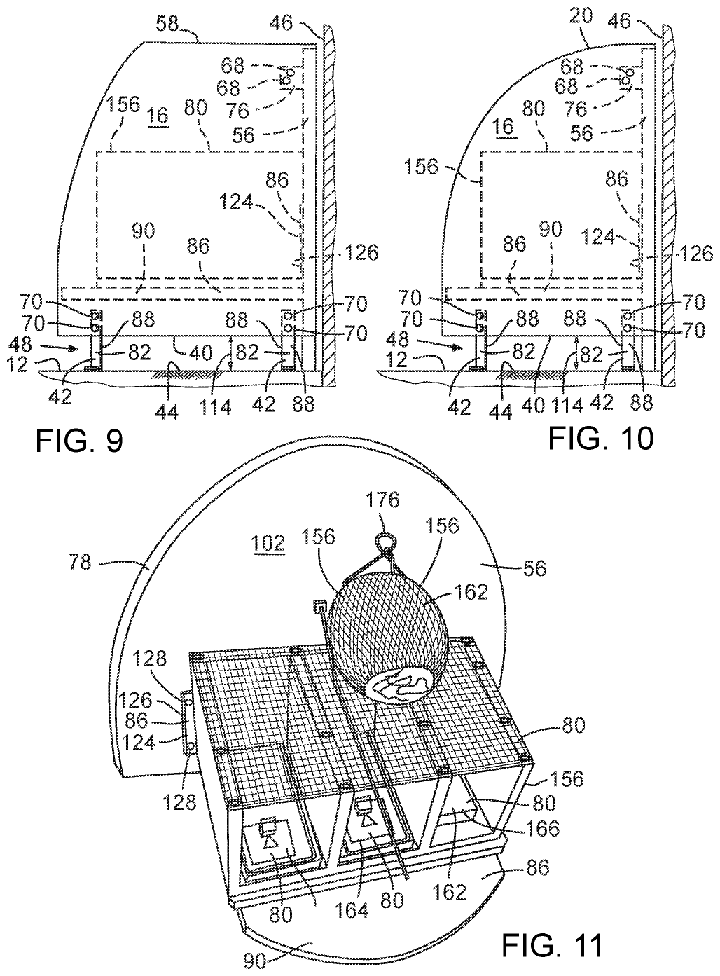

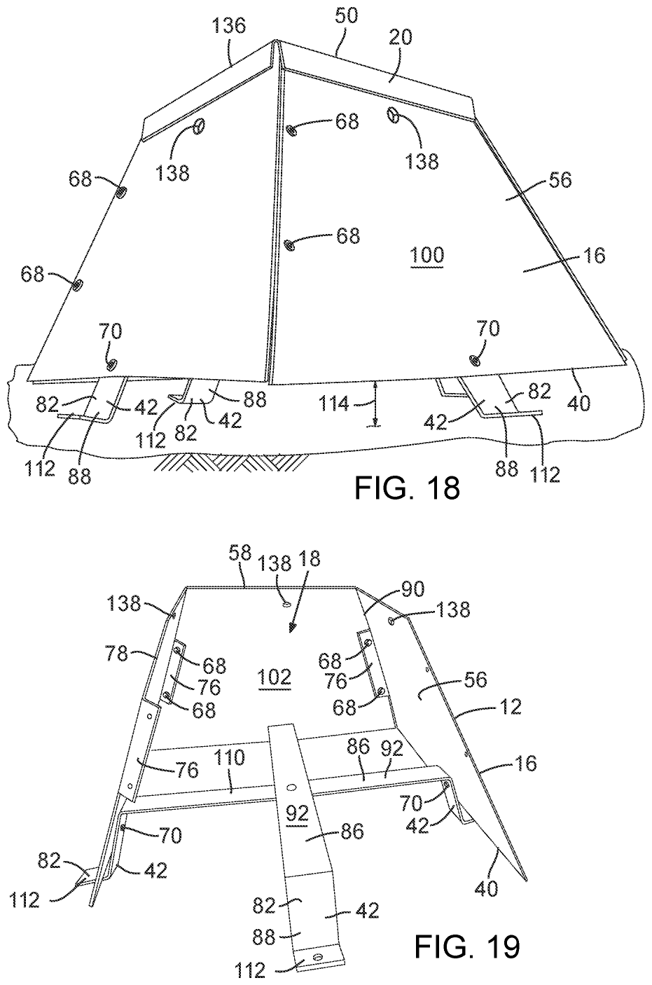

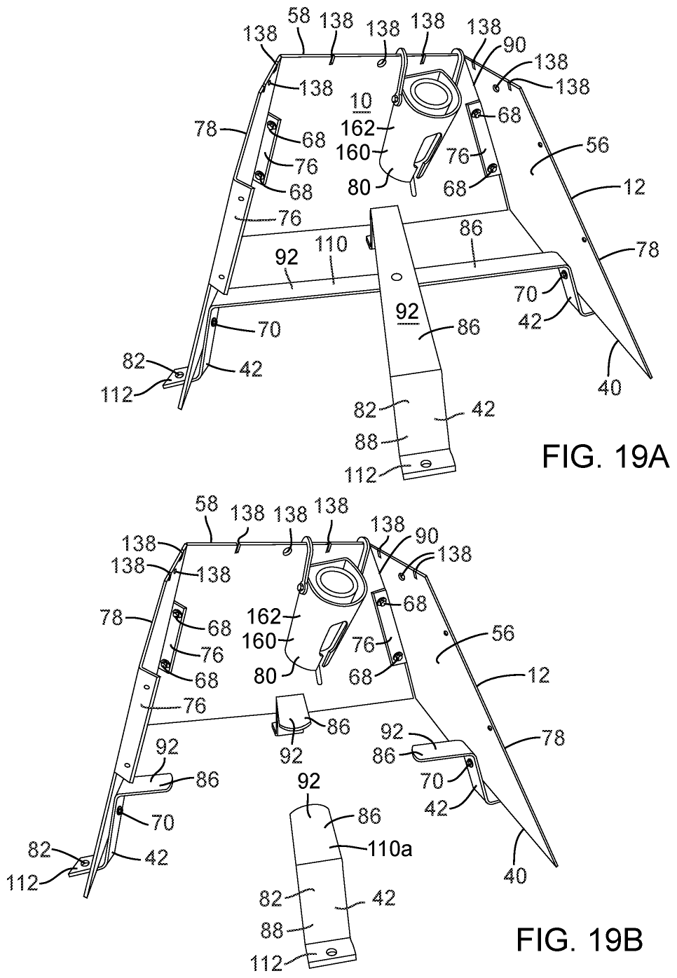

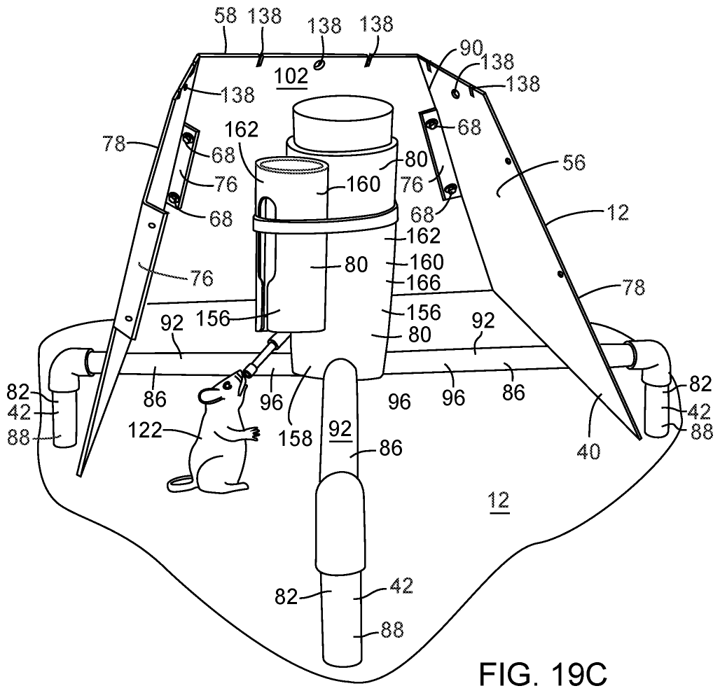

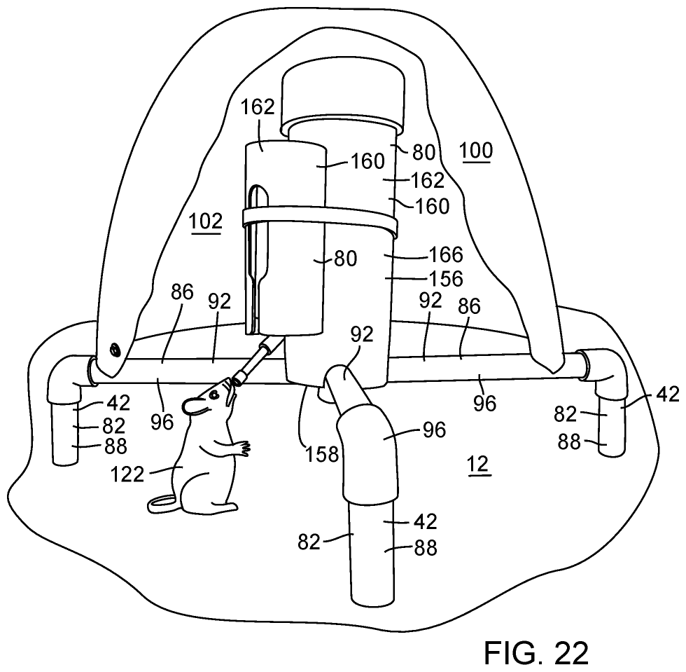

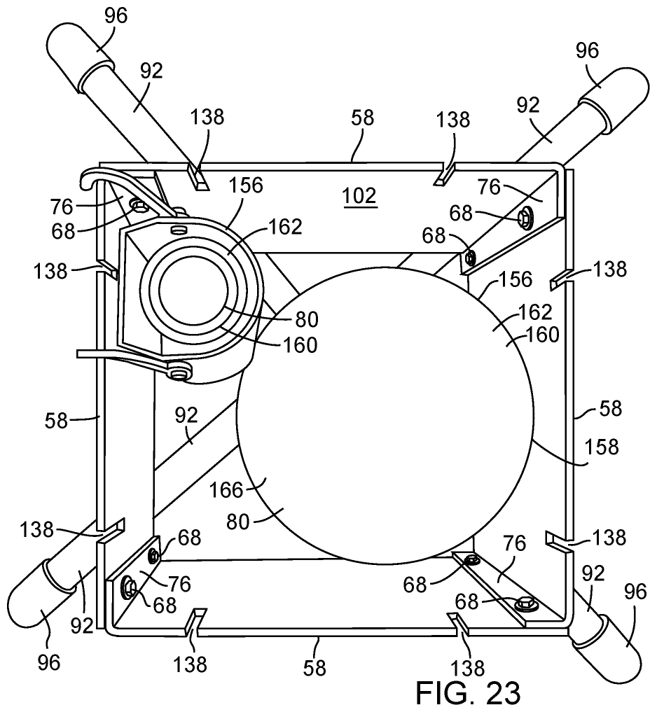

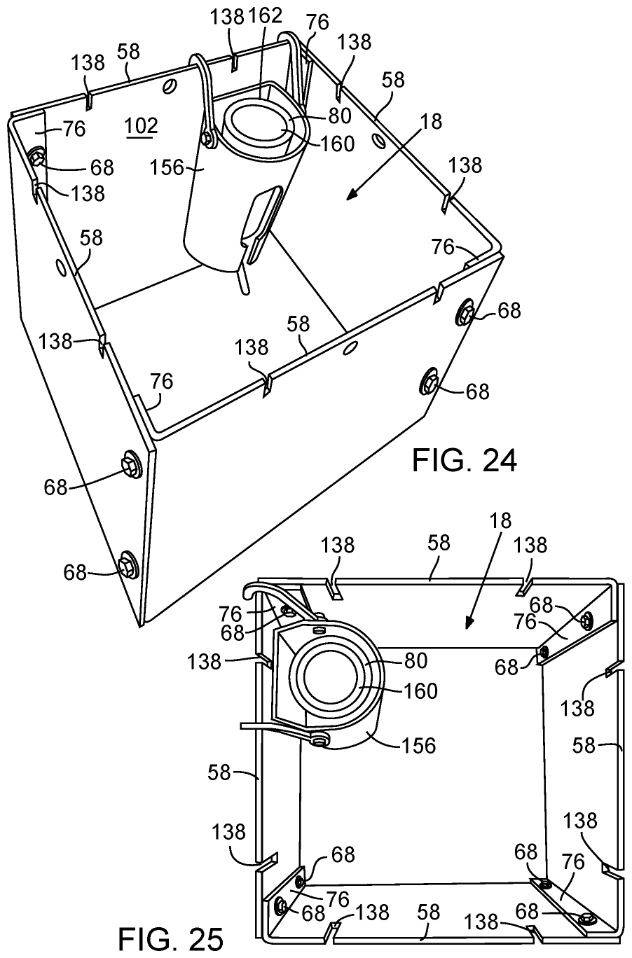

FIG. 7 is a rear perspective view of a truncated outer wall 16 for an embodiment of a wall-based enticement enclosure 10 that facilitates positioning against, or mounting to, an ambient wall or other substantially vertical surface 46; FIG. 8 is a side view of an embodiment of a wall-based enticement enclosure 10 mounted to an ambient wall; FIGS. 9 and 10 are side views of different embodiments of a wall-based enticement enclosure 10 with a truncated outer wall 10 and a wall panel 56, such as a back panel, to facilitate positioning near or against, or mounting to, an ambient wall or other substantially vertical surface 46; FIGS. 18 and 20 are side views of alternative embodiments of a ground surface-based enticement enclosure 10 having geometrically similar wall panels 56 to form the outer wall 10; FIGS. 19, 19A, 19B, 19C, and 21 are interior side perspective views of alternative embodiments of a ground surface-based enticement enclosure 10 having geometrically similar wall panels 56 to form the outer wall 16, with one of the wall panels 56 removed to show the interior volume 18; FIG. 22 is a top and front perspective view of another alternative embodiment of a ground surface-based enticement enclosure having a dome-like outer wall, with a portion removed to show an alternative suspension system; and FIGS. 23-25 are top perspective views alternative embodiments of a ground surface-based enticement enclosure 10 having geometrically similar wall panels 56 to form the outer wall 16.

With reference to FIGS. 1-10 and 18-25, the enticement enclosure 10 may form any exterior shape. The exterior shape may be polyhedral or non-polyhedral, which may have no straight lines or may have one or more aspects of straight lines or flat surfaces as well as curved lines or contoured surfaces. Polyhedral exterior shapes may include, but are not limited to, shapes that are tetrahedral, cubic (such as FIGS. 23-25), pyramidal (such as FIGS. 18, 19, and 19A-19C), prismatic, pentagonal, hexahedral, octahedral, and decahedral. These polyhedral exterior shapes may have substantially identical vertical and/or transverse sides or different vertical and/or transverse sides. Non-polyhedral exterior shapes may include curved shapes with polyhedral portion or sides or may include curved shapes without polyhedral portion or sides. Examples of non-polyhedral exterior shapes may include, but are not limited to, shapes that are spheroidal, spherical, ellipsoidal, ovoidal, conical, domed, and cylindrical. Moreover, these exterior shapes may be truncated at the top and have no major bottom surface (if any) and/or may be truncated vertically or transversely.

Accordingly, the outer wall 16 may be formed as a singular piece (regardless of the number sides) or from two or more separate side wall panels 56, such as the embodiments shown in FIGS. 7-10, 18-21, and 23-25. The wall panels 56 may have identical (or substantially identical) shapes and sizes, such as the panels 56 in FIGS. 18 and 19; or, they may have different shapes and/or sizes, such as the truncated outer wall 16 and the back panel 56. The shapes of the wall panels 56 may be polygonal or non-polygonal, which may have no straight lines or may have one or more aspects of straight lines or flat surfaces as well as curved lines or contoured surfaces. The wall panels 56 may have any shapes suitable for collectively forming a desired shape of the outer wall 16 or the shape of the enticement enclosure 10 as a whole.

In some embodiments, a perimeter of the outer wall 16 may include but is not limited to a curved cross-sectional profile, an arcuate cross-sectional profile, an elliptical cross-sectional profile, a polygonal cross-sectional profile, rectangular cross-sectional profile, a square cross-sectional profile, a hexagonal cross-sectional profile, or an octagonal cross-sectional profile. The perimeter of the outer wall 16 may include a cross-section at any elevation from the lower rim 40 to a wall top 58 of the outer wall 16 or to a wall top 60 of a secondary outer wall 22 of the cover 20. Similarly, an interior horizontal cross-sectional area may be defined by the interior surface 102 of the outer wall 16 at any given elevation position. (A total outer wall of the enclosure 10 may include the outer wall 16 and the secondary outer wall 22.) In many embodiments, a major horizontal cross-sectional perimeter of the outer wall 16 may be closer to or at the lower rim 40 than to that of either of the wall top 58 or wall top 60. Similarly, a horizontal major cross-sectional area of the enclosure 10 may be greater at or near the lower rim 40 than to that of either of the wall top 58 or wall top 60. Accordingly, in many embodiments, the perimeter at the lower rim 40 may be greater than or equal to the perimeter at either of the wall top 58 or wall top 60.

The outer wall 16 may be made from any suitable material, such as organic materials, polymers, plastics, resins, fiberglass, metals, or any combination thereof with or without reinforcement materials. The outer wall 16 may be 3D printed, injection molded, or formed by any suitable manufacturing process. In some embodiments, wall panels 56 are made from a sheet material, such as metal or a thermoplastic such as Kydex™, and are cut to a desired size and shape by a CNC milling machine. In some embodiments, the wall panels 56 may be flat to facilitate shipping.

If multiple wall panels 56 are employed, they may be made from the same materials as each other or may be made from different materials. In many embodiments, the outer wall 16 material is preferably washable to the extent that undesirable odors can be removed from the materials with simple washing procedures including but not limited to rinsing or washing with a cleaning agent that does not leave an undesirable scent or residue.

In some embodiments the wall panels 56 of the outer wall 16 are easy to connect to each other and are reversibly detachable. Reversibly detachable wall panels 56 may provide easy access to an interior volume 18 of the enclosure 10. Removable or reversible fastening agents, such as panel-fastening agents 68, leg-attachment mechanisms 70, leg anchors 54, and wall-mounting fasteners 72, may include but are not limited to one or more of snap-fit connectors, slots, and tabs, threaded fasteners (such as screws, bolts, and/or nuts), or non-threaded fasteners. The fastening agents may be made from plastic, metal, or other material(s). The panel-fastening agents 68 may cooperate with optional panel-securing holes 74, such as reinforced holes or non-reinforced holes, pre-established through the wall panels 56 and/or through optional tabs 76 that may extend transversely from panel edges 78. The panel-fastening agents 68 and the optional panel-securing holes 74 may be deemed a panel-securing system, for convenience.

The entry gap 48 and/or space underneath a pest control system 80 (as later described) may be created in a variety of ways, typically employing a support system 42, which may include but is not limited to a ground-support system 82, a side-mount system 84, or a suspension system 86. In some embodiments, the support system 42 may be formed integrally with the outer wall 16, the secondary outer wall 22, or the cover 20. For example, the outer wall 16 may have downward projections extending below the lower rim 40 that are configured to make contact with the relative ground surface 12.

In some embodiments, a ground support system 82 may include one or more legs 88, one or more leg anchors 54, and/or one or more leg-attachment mechanisms 70. The legs 88 may be detachable or permanently mounted and may be made from any suitably strong material, such as any material previously mentioned. In some embodiments, the legs 88 are made from bent metal plates.

The legs 88 may be attached directly or indirectly to one or more of the outer wall 16, the suspension system 86, an interior platform 90, the pest control system 80, or the cover 20 of the enticement enclosure 10. In many embodiments, when the legs 88 are attached to the outer wall 16, multiple legs 88 may be equally spaced apart along the lower rim 40 (or the interior platform 90, the pest control system 80, or the cover 20). However, the legs 88 need not be equally spaced. Some embodiments employ two, three, or more legs 88.

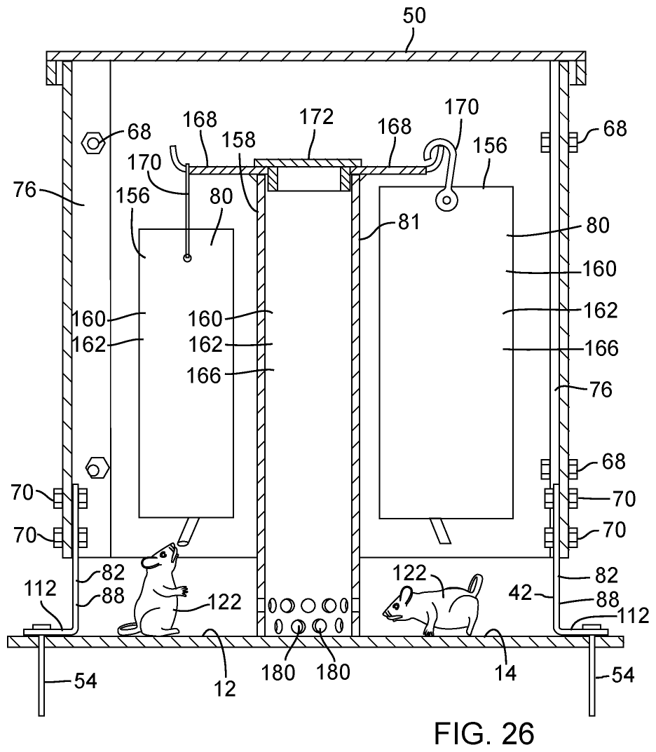

Alternatively, a single leg 88, such as a central pillar or pedestal 158 (such as shown in FIGS. 19C, 22, 23, and 26), may be attached to the relative ground surface 12 (such as the base 14) or the interior platform 90 (or the pest control system 80 or the cover 20) which can directly or indirectly support the outer wall 16. One will also appreciate that a combination of a central pedestal 158 and rim-associated legs 88 may be employed such as shown in FIG. 26.

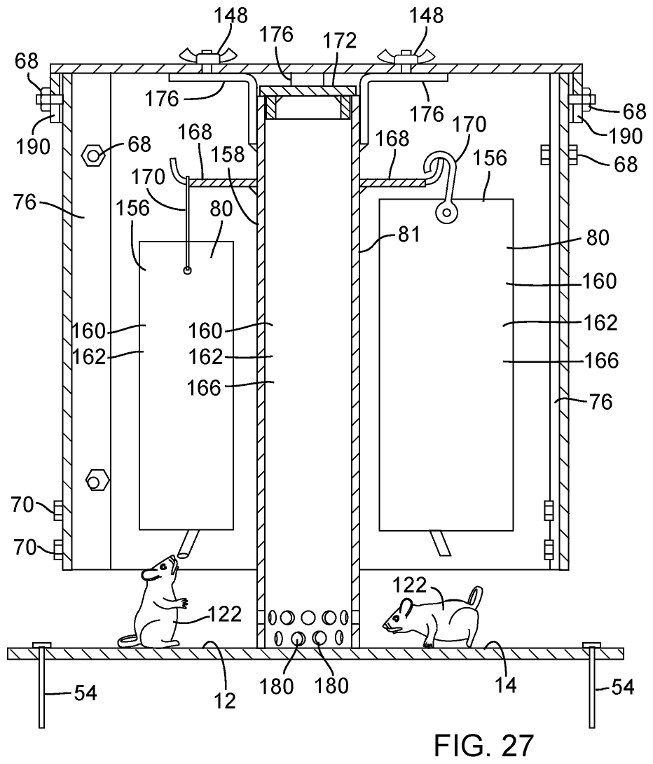

The central pedestal 158 itself may include or support the pest control system 80, the lure 160, the bait 162, and/or the food-based system 166. Moreover, the single leg 88 or central pedestal 158 may be configured to contain one or more components of the pest control system 80, the lure 160, the bait 162, and/or the food-based system 166 and dispense them through dispensing apertures 180. If the single leg 88 or central pedestal 158 is configured to hold or distribute food or bait 162, it may be covered by a pedestal cap 172 that can be easily removed to refill depleted components of the pest control system 80. FIGS. 26 and 27 show examples of a central leg 88 or pedestal 158 having arms 168 that support hanging mechanisms 170, which in turn support one or more components of the pest control system 80. The central pedestal 158 itself may have pockets, apertures, or hooks to support hanging mechanisms 170. The central pedestal 158 may also be configured to turn on its axis to act like a lazy Susan to present different components of the pest control system 80.

FIG. 27 shows an example of an embodiment in which a single leg 88 or the central pedestal 158 may be employed to support the cover 20. In some of such embodiments, the cover 20 may be connected to the pedestal cap 172, and/or the cover 20 can be connected to the pedestal 158 via pedestal brackets 176 such as by top fasteners 148. The cover 20 can be integral with the outer wall 16, or the cover 20 can be connected to the outer wall 16 such as via panel-fastening agents 68 to one or more side flanges 190 of the cover 20. Other lampshade-like embodiments are possible. One will appreciate that any of these embodiments may be configured with an external auxiliary feature.

With reference again to FIGS. 1, 3, 4, 13, 14, 16, and 19, 20, and 21, the legs 88 and/or the outer wall 16 (or platform) can be configured for permanent or reversible attachment to each other. Reversible leg-attachment mechanisms 70 may include but are not limited to snap-fit connectors, slots and tabs, threaded fasteners, or other fastening agents previously mentioned. In some embodiments, the legs 88 may be secured to the outer wall 16 via optional reinforced or non-reinforced leg-securing holes in the outer wall 16 and/or through tabs or reinforcing material 98 (such as a band) formed on or connected to an exterior surface 100 or an interior surface 102 of the outer wall 16. FIGS. 1, 3, 4, 9, 10, 13, 14, and 17-21 show direct connection of the legs 88 to the interior surface 102 of the outer wall 16, and FIGS. 5 and 6 show direct connection of the legs 88 to the exterior surface of the outer wall 16. One may appreciate that some of the legs may be attached to the interior surface 102 and some of the legs may be attached to the exterior surface 100 on any embodiment of the enticement enclosure 10. For convenience, the legs 88, the leg-securing holes, and the leg-attachment mechanisms 70 may be deemed part of a ground-support system 82.

With reference to FIGS. 13-23, some or all of the legs 88 may be connected directly to an interior platform 90, a suspension system 86, or a pest control system 80. For example, FIG. 13 provides a bottom perspective view of a ground surface-based enticement enclosure 10 having two independent support systems 42, including an outer-wall ground-support system 82a that employs legs 88a for supporting the outer wall 16 to be spaced apart from the relative ground surface 12 and a pest-control or platform ground-support system 82b for supporting a pest-control system 80 or an interior platform 90, such as a bait box 104, to be spaced apart from the relative ground surface 12. One may appreciate that the legs 88 or other implementations of the ground support system 82 may have a maximum support cross-sectional dimension or a maximum support cross-sectional area that is less than or equal to 10% (or less than or equal to 5%) of the respective major cross-sectional dimension or major cross-sectional area of the enticement enclosure 10 to reduce limitations on sightlines at the entry gap 48.

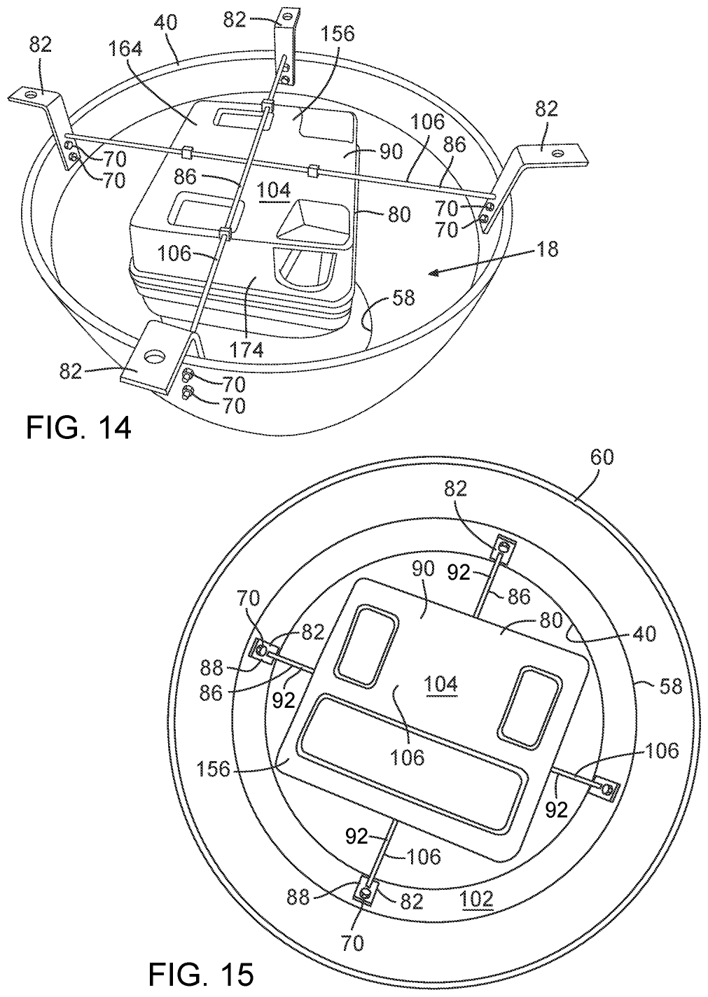

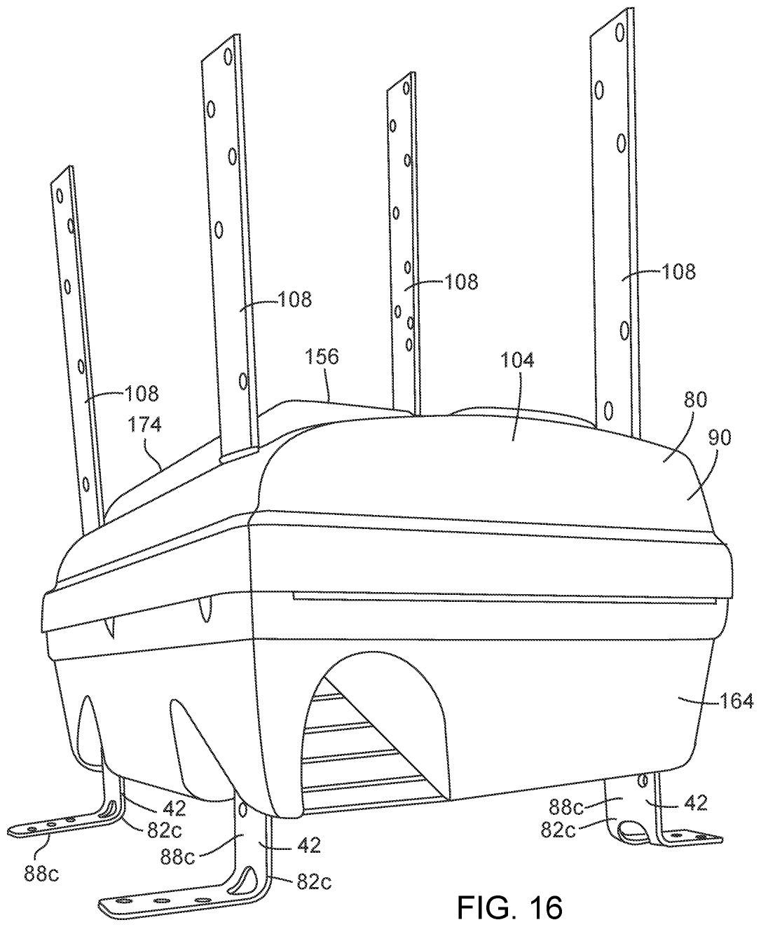

In another example, FIGS. 14 and 15 provide respective bottom and top perspective views of embodiments of a ground surface-based enticement enclosure 10 having an outer-wall ground-support system 82 that employs legs 88 for supporting the outer wall 16 to be spaced apart from the relative ground surface 12 and a suspension system 86 such as transverse suspension wires 106 for supporting a pest-control system 80 or an interior platform 90, such as a bait box 104, to be spaced apart from the relative ground surface 12. One may appreciate that the bait box 104 may function as both a pest-control system 80 and an interior platform 90.

FIGS. 13, 14, and 16 show the use of an entire conventional bait box, while FIG. 15 shows the use of a conventional feeding tray from within a traditional bait box without its housing. FIGS. 11 shows a pest control system 80 employing kill devices. The partitions between the kill devices help to limit the angles of approach for the target animal 122 so that its head is aligned for a clean kill to avoid prolonged suffering.

FIGS. 19, 19A, 19B, 19C, 21, 22, and 23 show alternative embodiments of a suspension system 86. One will also appreciate that the suspension system 86 may alternatively or additionally employ support mechanisms, such as suspension strips 110, rails, rods, steel rods, pipes 96, brackets 94, perches 110a, or other support mechanisms having strength suitable to support a pest-control system 80 and/or an interior platform 90.

With reference to FIGS. 14, 15, 19, 19A, 19B, 19C, 21, 22, and 23, one will appreciate that the suspension system 86 is located at a suspension elevation in proximity to the lower rim 40 such that the suspension elevation position is closer to the lower rim 40 than to the wall top 58 or the cover 20. One will also appreciate that each support mechanism, regardless of its type, has a suspension horizontal surface area (or suspension horizontal cross-sectional surface area) at the suspension elevation; and, the suspension system 86 (regardless of the type of suspension structures) has a cumulative suspension surface area (or cumulative suspension horizontal cross-sectional surface area) at the suspension elevation. In this regard, a majority of an interior horizontal cross-sectional area at the suspension elevation is greater than the cumulative suspension surface area (or cumulative suspension horizontal cross-sectional surface area), as disclosed in these figures. Similarly, a majority of the major cross-sectional area the enticement enclosure 10 has a major area value that is greater than a cumulative suspension surface area value.

Moreover, one will appreciate that a majority of the interior horizontal cross-sectional area at the suspension elevation is devoid of the cumulative suspension surface area (or cumulative suspension horizontal cross-sectional surface area), as disclosed in FIGS. 14, 15, 19, 19A, 19B, 19C, 21, 22, and 23. In other words, less than half of the interior horizontal cross-sectional area at the suspension elevation is occupied by the cumulative suspension surface area (or cumulative suspension horizontal cross-sectional surface area).

Similarly, a majority of the major cross-sectional area the enticement enclosure 10 is devoid of the cumulative suspension surface area (or cumulative suspension horizontal cross-sectional surface area). In other words, less than half of the major cross-sectional area the enticement enclosure 10 is occupied by the cumulative suspension surface area (or cumulative suspension horizontal cross-sectional surface area).

In some embodiments, less than 40% of the interior horizontal cross-sectional area at the suspension elevation is occupied by the cumulative suspension surface area (or cumulative suspension horizontal cross-sectional surface area). In some embodiments, less than 30% of the interior horizontal cross-sectional area at the suspension elevation is occupied by the cumulative suspension surface area (or cumulative suspension horizontal cross-sectional surface area). In some embodiments, less than 25% of the interior horizontal cross-sectional area at the suspension elevation is occupied by the cumulative suspension surface area (or cumulative suspension horizontal cross-sectional surface area). One will appreciate that the configuration of the suspension system 86 may provide enhanced airflow and enhanced line of sight and easy and obvious means of entry and escape for a target animal 122. Moreover, one will appreciate that the configuration of the suspension system 86 provides multiple positions of entry and escape from the volume above the suspension system 86.

In certain embodiments, the suspension system 86 has a vertical cross-sectional profile that is circular, such as those shown in FIGS. 14, 15, 19, 22, and 23. In certain embodiments, the suspension system 86 has a vertical cross-sectional profile that is rectangular, such as those shown in FIGS. 19, 19A, 19B, and 21.

The suspension wires 106 or suspension strips 110, may be made from the same material as the legs 88, outer wall 16, any material previously mentioned, or any other suitably strong material. The suspension system 86 may be attached (reversibly or nonreversibly) to the legs 88, the outer wall 16, and/or the cover 20 with or without a reinforcing material 98. The suspension system 86 may add structural integrity to the outer wall 16 or the enticement enclosure 10 as a whole.

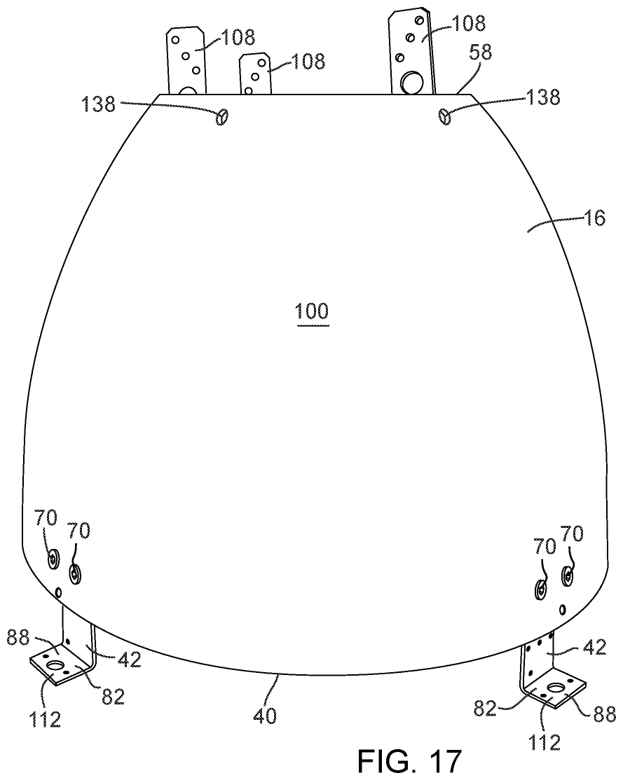

In yet another example, FIG. 16 provides a front and side perspective view of a pest-control or platform ground-support system 82c that is configured to support a pest-control system 80 or an interior platform 90, such as a bait box 104, to be spaced apart from the relative ground surface 12. The ground-support system 82c may have legs 88c that upright extensions 108 configured to support the outer wall 16 and/or a cover 20. One may appreciate that the upright extensions 108 may be completely separate from the legs 88c, such that the upright extensions 108 are separately connected pest-control system 80 or an interior platform 90 and function to support the lower rim 40 to be spaced apart from the relative ground surface 12. FIG. 17 provides a side view showing the upright extensions 108 protruding through the interior volume 18 of the enticement enclosure 10 to support the outer wall 16, the secondary outer wall 22, and/or a cover 20.

The legs 88 may be fashioned to have landing pads 112. In some embodiments, the legs 88 may be configured as stakes, or the legs 88 may be configured to have anchor points, such as receiving holes, to accommodate leg anchors 54, such as stakes, nails, or other fasteners, that may be secured to the relative ground surface 12 to maintain a desirable location of the enclosure 10 with respect to the relative ground surface 12. The legs 88 may also be adjustable to permit elevation adjustment of the lower rim 40 with respect to the relative ground surface 12 to establish a desirable entry gap height 114 for the entry gap 48 and/or to facilitate equalizing the entry gap height 114 of the entry gap 48 at different positions around the lower rim 40, if desirable such as in response to uneven ground terrain. The entry gap height 114 may be substantially uniform around the perimeter of the lower rim 40. In some embodiments, greater than 90% of the perimeter of the lower rim 40 is within 0.25 inches (0.64 cm) of the gap height. In some embodiments, the legs 88 may be weighted instead of, or in addition to, being anchored to the ground surface 44, or the legs 88 may be configured for weights to be attached to them.

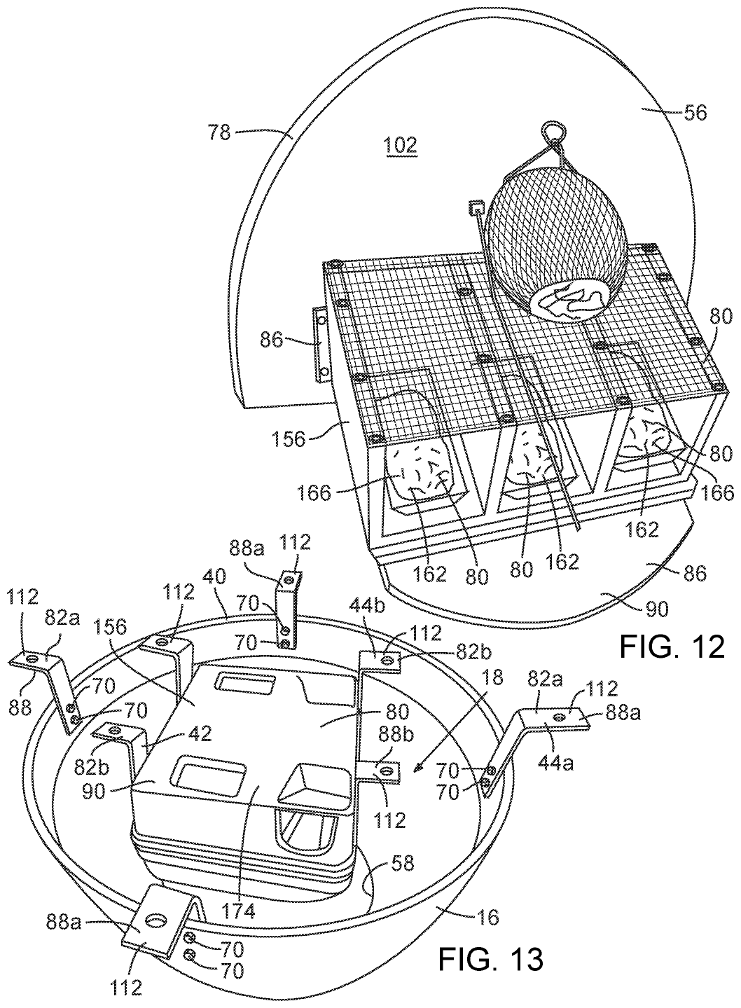

FIGS. 8-12 show embodiments of enticement enclosures 10 having a truncated outer wall 16 and a back panel 56 to facilitate positioning adjacent a substantially vertical surface 46, such as a fence or exterior house siding. In particular, FIG. 8 shows an embodiment of enticement enclosure 10 that is directly or indirectly mounted to a substantially vertical surface 46 by a side mount system 84. The side mount system 84 may employ a wall-mounting mechanism, such as wall mounting fasteners 72, to connect through a tab or other feature on a truncated edge 120, through a flat portion or wall panel 56 or a another relatively flat section of the outer wall 16 to the substantially vertical surface 46. Such flat wall panel 56 may be configured to be reversibly attachable to the remainder of the outer wall 16 to provide a person with easy access to the interior platform 90. Alternatively, the interior platform 90 may be directly or indirectly connected to the wall surface 46 by way of an alternative side mount system 84. The enclosure 10 may be mounted so that the lower rim 40 is at a desirable gap height 114 from the relative ground surface 12.

In some embodiments, the outer wall 16 and/or the interior platform 90 may be suspended away from the wall surface 46 by wall spacers so that the truncated edge 120 in proximity to the wall surface 46 may be spaced apart from the wall surface 46 to provide an entry gap 48 between the truncated edge 120 and the wall surface 46. The interior platform 90 may also be spaced apart from the wall surface 46 by wall spacers to provide enhanced line of sight for a target animal 122, such as a rodent.

FIGS. 8-12 also show a suspension system 86 that employs a panel-mount mechanism 124 for the interior platform 90. The panel-mount mechanism 124 may employ tabs, brackets 126 and/or platform-mounting fasteners 128, which may include any of the previously mentioned fasteners, different fasteners, or fasteners of different sizes.

In some embodiments (not shown), the enclosure 10 may be configured to mount via a suspension system 86 that can be used to suspend the enclosure 10 from an elevationally higher feature, such as a branch or a bird feeder 24, so that the lower rim 40 is suspended at an appropriate gap height 114 above the relative ground surface 12. In one example, the cover 20 may include a hook or ring through which a chain, wire, or rope can be suspended from the higher feature. The outer wall 16 of such enticement enclosure embodiments 10 may employ one or support stakes or other anchors to maintain a desirable position that may be impervious to wind. Moreover, the suspension system 86 may be used independently or in conjunction with a ground support system, such as one or more legs 88, to maintain the enclosure 10 at the desirable location and at the desirable gap height 114.

The entry gap height 114 may be selected to regulate the size of target animals 122 permitted to enter the enclosure 10. The entry gap height 114 may be less than or equal to a maximum height of a target animal 122 while on its four feet (target animal maximum height 130) plus a buffer distance 132. In some embodiments, the entry gap height 114 is less than or equal to a target animal maximum height. In some embodiments, the entry gap height 114 is less than or equal to 95% of a target animal maximum height or less than or equal to 90% of a target animal maximum height. In some embodiments, the entry gap height 114 is less than or equal to 2.5 inches (6.35 cm), less than or equal to 2.25 inches (5.72 cm), less than or equal to 2 inches (5.08 cm), or less than or equal to 1.75 inches (4.45 cm). In some embodiments, the entry gap height 114 may be greater than or equal to a maximum crawl height of the target animal 122. In some embodiments, the entry gap height 114 is greater than or equal to 1 inch (2.54 cm), greater than or equal to 1.25 inches (3.18 cm), greater than or equal to 1.5 inches (2.81 cm), or greater than or equal to 1.25 inches (3.18 cm).

These sizes may be appropriate for some populations of rats for example. These sizes may be adapted for specific species or they may be adapted for specific types of locations. For example, urban rat populations may have different heights than rural rats. Moreover, the gap height 114 may be adapted to accommodate for specific geographic locations and account for genetic drift. One may also appreciate that the gap height 114 may be much smaller if the target animals 122 are mice, for example. Moreover, the gap height 114 may also be configured to select for different types of target animals. Very low gap heights 114 can select for arachnids. Gap heights 114 up to about 0.25 inch may select for snakes. Gap heights 114 between about 0.25 inch and 0.75 may select for mice (and exclude many types of rats). Appropriate pest control system components may be used with regard to the selected type of target animal 122.

In some embodiments, the entry gap 48 is continuous around a perimeter of the lower rim 40. In some embodiments, the entry gap 48 is substantially continuous around a perimeter of the lower rim 40. In some embodiments, the entry gap 48 includes greater than or equal to 95% of a perimeter of the lower rim 40, greater than or equal to 90% of a perimeter of the lower rim greater than or equal to 85% of a perimeter of the lower rim 40, includes greater than or equal to 80% of a perimeter of the lower rim 40, includes greater than or equal to 75% of a perimeter of the lower rim 40, includes greater than or equal to 60% of a perimeter of the lower rim 40, or includes greater than or equal to 50% of a perimeter of the lower rim 40.

In some embodiments, the entry gap 48 provides horizontal sight lines from any entry point beneath the lower rim 40 through greater than or equal to 95% of a perimeter of the lower rim 40, provides horizontal sight lines from any entry point beneath the lower rim 40 through greater than or equal to 90% of a perimeter of the lower rim 40, provides horizontal sight lines from any entry point beneath the lower rim 40 through greater than or equal to 85% of a perimeter of the lower rim 40, provides horizontal sight lines from any entry point beneath the lower rim 40 through greater than or equal to 80% of a perimeter of the lower rim 40, or provides horizontal sight lines from any entry point beneath the lower rim 40 through greater than or equal to 70% of a perimeter of the lower rim 40.

The cover 20 may have an upper exterior surface 136 and an underside surface and may cover most or all of the area defined by the perimeter of the wall top 58. However, the cover 20 may include one or more ventilation holes 138 that may be part of a ventilation system 140 as later described. In many embodiments, the perimeter of the upper exterior surface 136 may be greater than the perimeter of the wall top 58. The cover 20 may be made from one or more of the same materials that can be used to make the outer wall 16 or the cover 20 may be made from one or more different materials.

The cover 20 can be configured to reversibly mate with or reversibly engage with and detach from the wall top 58 or the outer wall 16, such as in a snap- or compression-fit manner. Alternatively or additionally, one or more top-fastening mechanisms 144 may be employed that either permit complete separation of the cover 20 from the outer wall 16 or maintain direct or indirect connection of the cover 20 to the outer wall 16. These top-fastening mechanisms may either hold the cover 20 in place or lock it to the outer wall 16. For example, a latch mechanism can lock the cover 20 to the outer wall 16. Similarly, a plate, strap, other connector 146 that bridges the cover 20, such as at the secondary outer wall 22, and the outer wall 16 may be locked together with one or more fasteners 148 (such as any fastener previously mentioned) through the connector 146 and into fastener holes 150 in the respective cover 20 and the outer wall 16. In some embodiments, the top-fastening mechanism 144 employs a quick-release fastener. Alternatively or additionally, the top-fastening mechanism 144 may employ a clasp, a slot, or a peg. Yet other embodiments may employ one or more hinges, with or without additional connectors 146. The cover 20 and its the top-fastening mechanism 144 may provide the enticement enclosure 10 with easy access to the interior volume 18, such as for servicing the pest control system 80 or any of its components.

With reference to FIGS. 8 and 10, the outer wall 16 and the cover 20 may be a solitary integrated unit forming one continuous exterior surface 100. In some embodiments, the cover 20 may include a secondary outer wall 22 that extends downwardly toward the outer wall 16. In some embodiments, the secondary outer wall 22 is configured to surround the perimeter of the wall top 58 or slide over the wall top 58. Moreover, the secondary outer wall 22 may have a cross-sectional profile shape that corresponds to a cross-sectional profile shape of the outer wall 16, and a downward edge 152 of the secondary outer wall 22 may be configured to slide around the wall top 58 of the outer wall 16.

The enticement enclosure 10 may include a ventilation system 140 that may utilize the entry gap 48 at the lower rim 40 and one or more vents 142, such as ventilation holes 138 in one or more of the cover 20, the outer wall 16, or the secondary outer wall 22. The ventilation holes 138 may be relatively small, especially if they are not shielded such as by an extended over cover or external auxiliary feature 154, or they may be relatively large openings if protected by the cover 22 or an external auxiliary feature 154.

The ventilation system may also include other design features of the outer wall 16, the secondary outer wall 22, and the cover 20. For example, the perimeter of the lower rim 40 may be larger than the perimeter of the top 50 of the cover 20 which encourages airflow having a vertical component.

In some embodiments, the vents 142 of the ventilation system 140 may employ spacing, such as covered spacing, between the secondary outer wall 22 and the outer wall 16. For example, the spacing between the secondary outer wall 22 and the outer wall 16 may be created by one or more bumps or other spacer features on the exterior surface 100 of the outer wall 16 or one or more bumps or other spacer features on an interior surface 102 of the secondary outer wall 22 so that air can readily pass through the effective vent(s) 142 between the secondary outer wall 22 and the outer wall 16.

In some embodiments, the ventilation system 140 may employ protective flaps. To cover the vents 142 if they are not otherwise covered, such as to inhibit entry of rainwater. The ventilation system 140 may also employ interior baffles. Moreover, the ventilation system 140 may employ a fan that can be set to move air through the interior volume 18, whenever airflow is detected to drop below a minimum amount and/or over a specified duration.

The ventilation system 140 may be configured to draw ambient air through the entry gap 48 into the interior volume 18 and through one or more of the vents 142 positioned elevationally higher than the lower rim 40. Thus, the airflow provided by the ventilation system includes a vertical air flow component that may provide cooling to an internal auxiliary feature 156, such as a pest control system 80, its lure 160, and/or its bait 162. Air flow cooling in warm weather or sunny conditions may extend the useful life of lures 160, baits 162, and other components of the pest control system 80, potentially reducing the amounts of these components used overall and resulting in significant savings. One will appreciate that higher temperatures can degrade or shorten the life of components of a pest control system 80, such as its lure 160 and/or its bait 162.

The ventilation system may also extend the usable hours per day for the pest control system 80, especially in warmer climates. During certain parts of a day, conventional bait boxes may become too warm to entice a target animal 122 to enter. In contra distinction, the ventilation system 140 may provide sufficient cooling that the target animals 122 are enticed to utilize the pest control system 80 during more hours of the day.

The upward air flow from around the lower rim 40 and up through vent holes 138 and/or seams may also serve to disperse attracting scents from the lure 160 and/or baits 163 to be higher than the level of the ground surface 44, thus extending their effective attraction range. Stress in the target animals 122 may be lowered by the air flow because the air flow allows danger scents to be detected more efficiently by visiting target animals 122. In some embodiments, the ventilation system is configured to inject attracting scents into a prevailing wind pattern from greater than or equal to 12 inches (30.5 cm), from greater than or equal to 18 inches (45.7 cm) above ground surface 44, from greater than or equal to 20 inches (50.8 cm) above ground surface 44, from greater than or equal to 22 inches (55.9 cm) above ground surface 44, or from greater than or equal to 23 inches (58.4 cm) above ground surface 44.

As previously discussed, the interior platform 90 may be supported by a suspension system 86 that may be connected to and/or supported by legs 88, the outer wall 16, the secondary outer wall 22, a wall panel 56, and/or the cover 20. The interior platform 90 may be positioned at or elevationally higher than the lower rim 40 and is generally configured to support an internal auxiliary feature 156. The interior platform 90 may also be spaced apart from the outer wall 16 or a wall surface 46 to provide enhanced airflow and enhanced line of sight and easy and obvious means of entry and escape for a target animal 122. Moreover, one will appreciate that the configuration of the platform 90 provides multiple positions of entry and escape from the volume above the platform 90.

In some embodiments, the platform 90 or the internal auxiliary feature 156 may have a side perimeter that is positioned so that it has a minimum spacing of 2.5 inches (6.35 cm) from greater than or equal to 50% of the nearest points on the interior surface 102 of the outer wall 16, that is positioned so that it has a minimum spacing of 3 inches (7.62 cm) from greater than or equal to 50% of the nearest points on the interior surface 102 of the outer wall 16, that is positioned so that it has a minimum spacing of 2.5 inches (6.35 cm) from greater than or equal to 75% of the nearest points on the interior surface 102 of the outer wall 16, that is positioned so that it has a minimum spacing of 3 inches (7.62 cm) from greater than or equal to 75% of the nearest points on the interior surface 102 of the outer wall 16, that is positioned so that it has a minimum spacing of 2.5 inches (6.35 cm) from greater than or equal to 90% of the nearest points on the interior surface 102 of the outer wall 16, or that is positioned so that it has a minimum spacing of 3 inches (7.62 cm) from greater than or equal to 90% of the nearest points on the interior surface 102 of the outer wall 16.

The interior platform 90 may be a solid surface or a mesh and made from any previously mentioned disclosure material. Moreover, it can be made from wood or any material that can provide a solid or mesh surface and adequate support for a target animal 122 and an internal auxiliary feature, such as a pest control system 80, tunnel, ladder, water dispenser, camera, and/or attractant. (Live cameras may be useful for monitoring activity and especially for determining when baits have been used up.)

The pest control system 80 may include one or more of trap 164 or a feeding station for providing a food-based system 166. The traps 164 may include one or more kill mechanisms, such as snap devices or electrocution devices; or, the traps may include live traps (perhaps with a magnetically coupled trap status indicator). Similarly, food-based systems 166 may include poisons or contraceptives added to, or disguised with, bait 162 or other attractant. In some embodiments, the pest control system 80 is a rodent control system.

The kill mechanism may be any commercially available kill device, and the poison may be any commercially available, and preferably ecologically acceptable, poison. In some embodiments the kill device may incorporate or be adapted for inert gas euthanasia. Moreover, the poison may be a component of an EPA-approved lethal bait 162.

The contraceptive may include any commercially available contraceptive that is effective for the target animal 122. The bait 162 can be a food or attractant. The food may be any commercially available food acceptable to or preferred by the target animal 122. Some rodents, such as rats in particular, may prefer sunflower seeds. In some embodiments, the food is washed to remove nonnatural odors.

In some embodiments, the pest control system 80 may also dispense health-related treatments to the target animals 122. Employing health-related treatments may be especially desirable where contraceptives or other no kill control means are employed. The treatments may eliminate zoonotic diseases carried by rodents, or the treatments may eliminate the vectors carried by rats or mice, for example. This approach would permit the humane no-kill pest control system 80 for the rodents while eliminating humans to exposure to some of the diseases that rodents carry. These health-related treatments may be useful in the presence of kill-related poison control systems for animals that do not partake of the poisons (or enough of the poisons) or that do not interact with the kill devices.

In some embodiments, antibiotics such as amoxicillin or metronidazole, can be applied via a dust-dispensing system or dispensed via the water dispenser to address typhus, leptospirosis, giardia, and/or plague. The dust-dispensing system or the water dispenser can also be used to apply or dispense insecticides against flees, ticks, or mites. A dust-dispensing may be as simple as one or more dust containing devices positioned within the interior volume 18 above the entry gap 48. These dust dispensers may release treatment dust in response to by contact with the target animal 122, or they may be triggered to release dust in response to movement with the interior volume. In some embodiments, antivirals such as ivermectin may be dispensed via the water dispenser to address Hunta virus. Dust or other types of dispensers may be employed to poison or otherwise control nontarget pests, such as ants, that might eat pest control system components or whose presence might deter use by the target animal 122.

The attractant may be any commercially available attractant. In some embodiments, the attractant includes a food or food-based scent effective for attracting the target animal 122. In some embodiments, the attractant or lure 160 includes fresh water. The different variations of the pest control system 80 can be contemporaneously or sequentially, and they can be changed an adjusted as the population dynamics change.

Because the pest control system 80 may include a poison, the enticement enclosure 10 may include characteristics sufficient to meet EPA requirements for all levels of deployment as a stand-alone bait station. Moreover, the enticement enclosure 10 may be configured to provide protection against access by cats, dogs, children under 6 years old, and non-target animals, such as those that are larger than rodents. In this regard, many of the components of the enticement enclosure 10, such as the outer wall 16, the cover 20, the top fastening mechanism 144, the legs 88, and/or the leg anchors 54, may be configured to meet the EPA standards and protect against unintentional harm. One will appreciate that the enticement enclosure 10 is a man-made structure that is designed to conform with rodenticide and contraceptive labels meeting EPA qualifications.

In some embodiments, a commercially available pest control housing 174 may be employed in the interior volume 18 such as on platform 90 (or as the interior platform 90) to house the poisons or baits 162 of the pest control system 80. Some commercially available baits 162, lures 160, or food-based systems 166 are shown in FIGS. 19A, 19B, 19C, and 22-26.

The enticement enclosure 10 may also house a lure 160 spaced apart from the other features of the pest control system 80. The lure 160 may be attached to the interior surface 102 of the outer wall 16 or secondary outer wall 22, or the lure 160 may be suspended from an interior surface of the cover 20, either suspended by a hook 176, a chain 178, or other attachment mechanism. The lure 160 may contain an attractant and/or bait and be suspended higher that the other features of the pest control system 80 to take advantage of the ventilation system 140 to gather the bait scents and other attractant scents from the lure 160 and then distribute them into an airstream above the enticement enclosure 10. The bait 162 or attractant of the lure 160 may be contained in a netting or other deterrent making it difficult to remove. In some embodiments, the lure 160 includes water. One will appreciate that the enticement enclosure 10 may be successfully deployed without additional attractants.

The enticement enclosure 10 may also house a trap status indicator flag and/or an electronic system to remotely indicate one or more of trap status and success, bait monitoring, consumption and other indicators of conditions, or alarms and devices for repelling non-targeted animals.

The enticement enclosure 10 may also employ a heater or other climate control device to make the enclosure 10 more enticing or to heat the bait 162 or lure 160. For example, some pest animals such as rats tend to forage at dawn and dusk; however, the usable time within these periods can be somewhat limited by colder temperatures in colder climates. By heating the enticement enclosure 10 by as little as only a few degrees above the ambient temperature in such colder climates, one can extend the amount of time that the target animals 122 can make use of the enticement enclosures 10. Even a half hour of extra time can make a huge difference in the success rate of use by the target animals. Moreover, one will appreciate that some baits 162, lures 160, or other components of the pest control system 80 may congeal, solidify, or freeze at lower temperatures and make such components relatively unobtainable to the target animals 122 at such lower temperatures. Thus, by supplying heat to the enticement enclosure 10 or to its baits 162, its lures 160, or its other pest control system components, one can significantly increase the use by target animals 122. Additionally, temperature can be controlled to selectively entice different types of pests. Finally, one will appreciate that the enticement enclosure 10 may itself be configured to retain heat such as through the use of heat-absorbent exterior coloring and/or insulated outer walls 16 and covers 20, as described herein.

As previously discussed, the cover 20 may support or be connected or be positioned near or under an external auxiliary feature 154, such as a water supply feature 28 or a food distribution feature. The water supply feature 28 may include a bird bath and/or a fountain. In some embodiments, a water supply feature, such as a water dispenser with or without a dish, may alternatively or additionally be provided within the interior volume 18. The food distribution feature may include a bird feeder and/or a squirrel feeder.

In some embodiments, the enticement enclosure 10 may be configured or colored to camouflage with its surrounding and/or the pest enticement enclosure 10 may configured or colored to be aesthetically pleasing to a human, such as configured or colored to look like garden art. Moreover, the enticement enclosures 10 can be incorporated into permanent landscape features and, if desirable well-hidden from public view. These landscape features may be natural, such as rock formations, or they may be artificial, such as park benches, statues, or planters. The enticement enclosures 10 can be built into these features or buildings during new construction, or they can be added to existing features and buildings.

In some embodiments, the target animal 122 is a rodent, such as a mouse or a rat, and the enticement enclosure 10 may be specifically configured to attract and pacify the target animal 122. For example, the entry gap height 114 may be adjusted to facilitate entry of medium-sized target animals 122 and to slow entry of larger-sized target animals 122. In addition, the interior volume 18 may have size characteristics that are configured to facilitate comfort while inhibiting nesting within the enticement enclosure 10. Moreover, enticement enclosure 10 may be specifically configured to attract and pacify the specific species of the target animal 122, such as Rattus norvegicus or Rattus rattus. For example, the attractant employed in the lure 160 may be target animal group selective or species selective.

More generally, the enticement enclosure 10 may be configured for pacifying neophobia of a target animal 122. Many features of the enticement enclosure 10 are adapted to modify the behavior of target animals 122, reducing their stress levels, and make them more comfortable entering and dwelling in the enticement enclosure 10 and providing more time in the enticement enclosure 10 to interact with the pest control system 80.

The various embodiments and their variations may incorporate an appropriate amount of open space within the interior volume 18 with overhead protection, long lines of sight to help detect threats, open access to entry with an appropriately sized entry gap height 114, and multiple exit paths for rodents (or other target animals 122) to detect and evade danger. Characteristics of the entry gap 48 and the outer wall 16 may cooperate to amplify exterior sound within the interior volume 18 to warn the rodents of danger. All of these features contribute to associate the enticement enclosure 10 as a safe place to visit.

The enticement enclosure 10 may be employed to attract target animals 122 away from undesirable locations for them from a human perspective, such as gardens, sheds, crawl spaces, dwelling interiors, and food storage areas. Moreover, the enticement enclosure 10 may be employed to attract the target animals 122 to change their travel patterns and spend more time near the enticement enclosure 10.

In some embodiments, the enticement enclosure 10 provides a rat and rodent stress- and fear-reducing method and device that may be employed with any conventional traps 164, baits 162, or contraceptives.

Some embodiments include a hollow beehive-shaped enticement enclosure 10, having four optional legs 88 of an adjustable length to create a rodent entry (and exit) gap 48 between the lower rim 40 and the relative ground surface 12 that can regulate the size of rodents accessing the interior volume 18 of the enticement enclosure 10, and that can allow these rodents to be calmly introduced to traps 164, baits 162 and other internal auxiliary features 156 or other components of the pest control system 80 placed within the interior volume 18. Other internal auxiliary features 156 may include shelfs or ledges at various levels for various reasons, within, and/or, as part of the enticement enclosure 10. The enticement enclosure 10, along with a removable flat base 14, provides options for securing the entire unit to the ground surface 44, a fence or wall surface 46, or other landscape structures or features to meet possible EPA requirements for using specific EPA listed rodenticides.

In some embodiments, the enticement enclosure 10, with its optional removable cover 20 attached by a pivoting device, employs four legs 88 to provide a substantially uniform entry gap 48 between the lower rim 40 and the relative ground surface 12. The legs 88 may be attached to the optional base 14 and to the outer wall 16 with removable fastening agents 54 and 70, respectively, for ease of service and maintenance. The optional base 14 may provide a place or location to drive spikes, stakes, anchors, into the ground surface 44; or, the enticement enclosure 10 may be held in place with weights or through other means, such as suspension of a truncated outer wall 16 from a wall surface 46, post, fence, or other suitable substantially vertical surface or object with various fastening agents 72.

Some embodiments of the enticement enclosure 10 include some or all of: a water supply feature 28 (such as a rodent drip watering system); a removable cover 20 and/or openable side hatches, an internal dispenser for bait 162 (such as seeds); a flexible hose attached to an access port for adding baits 162 and inserting inspection devices; interior scaffolding for runways, attachment tabs for attaching other devices; integrated interior and/or exterior bait 162, lure 160, and attractant dispensers; one or more heaters for water, baits 162, and/or lures 160 with or without climate control; electronic attachments and/or components to observe, attract, discourage, or kill rodents; attachments for introducing and containing gasses for euthanasia, invertebrate control, or other reasons; wild-bird feeder 24 and/or squirrel feeder; attracting and/or repelling devices and traps 164; a trap status indicator flag; electronic system to remotely indicate one or more of trap status and success, bait monitoring, consumption and other indicators of conditions; alarms and devices for repelling non-targeted animals; differing exterior shapes for utility and decorative considerations; baffles, or other methods and devices to inhibit tampering and/or to enhance the security of rodenticide and trap placements for compliance, if necessary, with EPA Tier 1 and Tier 2 bait enclosure requirements; separate, removable, interchangeable, and specific use accessory appliances, modules, layers and/or structures; water fountains and/or bird baths 26 whether attached, connected, or unattached; tubing, pipes, and/or other devices or structures installed to encourage rodent travel and access to and from the enticement enclosure 10.

Similarly, the associated method may also include one or more of the following steps: attachment by any means, including but not limited to, suspension by cable, chain 178, or rope, to interior and exterior walls 46 of homes and other buildings, posts, fences, decorative items, bus stops and food court architecture, statues and park structures, refuse containers, trees, roofs, and mobile carts, vehicles, tunnels, dividers, storage bins, or placement under and adjacent to wild-bird feeders 24, chicken coops, and other sources of rodent attracting materials; use of specific scents and attractants and repellents, as well as odor removal procedures; installation of ropes, platforms or other materials to trees and/or structures, attached from, or near to the enticement enclosure 10, that provides a pathway to and from the vicinity of the enticement enclosure 10; or installation pipes ropes, and other devices, on or near the ground, connecting to and or adjacent to the enticement enclosure 10, that by their size and positions, provide selective cover and safety to rodents going to and leaving the enticement enclosure 10; and/or use of reflective coatings, insulation for differing climates, custom colors and/or artwork, roof rat- and other rodent-specific adaptations, sewer use adaptations, modifications for incorporation into refuse containers and/or animal feeders, elongated shapes, monitoring devices, video recording devices, and/or telemetry connections.

The enticement enclosure 10 provides a pest management system that is unlike commercially available devices and solutions because it can be used to improve and increase the success of the commercially available devices, or it can be effective when used by itself, as a complete trapping- or bait-dispensing pet management system. The enticement enclosure 10 provides a way to attract rodents to these other pest control devices, which are designed to capture, kill, poison, or dispense contraceptives (and optional treatments). The enticement enclosure 10 may decrease overall labor and product costs to achieve significant reductions in rat and rodent populations. The enticement enclosure 10 may incorporate the latest research, along with field studies and real-world experience, in design and implementation. The enticement enclosure 10 may be ideal for placing under, or adjacent to, back yard bird feeders 24, watering devices, birdbaths, squirrel feeders, and/or chicken coops. The enticement enclosure 10 offers additional protection against disturbance or dislocation for industry standard devices and offers an extra margin of safety against tampering by children and pets. In some embodiments, additional deflector blocks can be added to inhibit tampering of the contents by certain animals (such as racoons) or children. The air flowing upward inside, lowers the temperature inside the enticement enclosure 10, and extends the effective usefulness of baits 162 and lures 160 deployed therein.

The enticement enclosure 10 is structurally designed to attract and introduce rodents to a variety of other devices by lowering the stress rats and other rodents feel when encountering new objects and situations. Rats and other rodents instinctively avoid new objects, such as traps 164, baits 162, and bait boxes 104, when first encountered in their environment. Acceptance of new things and objects by rats, including smells, noises and other environmental conditions, typically takes three to five or more days. Moreover, rats hate to enter any confined space without a second way out, because a bigger animal may follow them in, trapping them with no path for escape. This inherited fear is one reason for the poor acceptance of rodenticides dispensed in poorly designed boxes.

The enticement enclosure 10 overcomes this instinctual fear by its design features including, multiple escape paths, long and unobstructed lines of sight, overhead solid cover 20, a spacious resting area in the interior volume 18, and air flow from outside. Moreover, one will appreciate that the configuration of the enticement enclosure 10, including the configuration of one or more of its structures (such as the entry gap 114, the platform 90, and/or the suspension system 86) provides multiple positions of entry and escape from the enticement enclosure 10. The fear reduction is a direct result of the design and shape of the enticement enclosure 10 and its various features. The air flows from the outside makes the detection of danger by scent easier that favor the early detection of danger, thereby reducing fear and stress levels in visiting rats and rodents. The long and unobstructed sight lines lower stress associated with high-density urban rat populations (and limited lines of sight). The interior layout affords a visiting rat with overhead protection from overhead predators (such as owls) and space enough to reduce stress induced by crowding. The spacious interior volume 18 lowers fear and stress by offering multiple ways for a rat to sense and avoid aggressive colony members and other dangers. The open spacing around objects inside of the enticement enclosure 10 and protected space overhead promotes a sense of security to rats and encourages them to enter and explore. The entry gap height 114 is adjustable to give an escape advantage to smaller, non-dominant rats, thus encouraging more colony members to utilize the stress-reducing features of the enticement enclosure 10 sooner (reducing neophobia to the enticement enclosure 10), so the rats can be caught or treated much more quickly than possible with current commercially available equipment. The enticement enclosure 10 thereby provides ideal low stress opportunities to introduce rats to and acclimate them to various types of control traps 164, baits 162, and contraceptives inside.

Moreover, the enticement enclosure 10 may be used facilitate research with respect to new baits, poisons, contraceptives, and/or treatments. Because the enticement enclosure 10 elicits a fear-reducing response, rodents will be more likely to try and readily accept or be exposed to new compositions for testing, and the rodents may be more willing to interact with new pest control system devices.

The enticement enclosure 10 lowers labor costs by decreasing the number of labor hours necessary to reach a defined reduction in rat populations. The enticement enclosure 10 reduces the number of individual trap and bait placements necessary in a given situation. Each trap or bait station installed in the enticement enclosure 10 becomes much more attractive to rodents. Moreover, the enticement enclosure 10 utilizes this fear-reducing effect to encourage longer and more frequent visits to the enticement enclosure 10 resulting in the rats becoming used to, and less wary of, rodent control tools, traps 164, and baits 162 that are positioned under the outer wall 16 in the interior volume 18 of the enticement enclosure 10.

Additionally, the enticement enclosure 10 protects the pest control system components from the elements and provides an additional level of security from mishaps caused by other animals and humans. Placing the enticement enclosure 10 under active wild-bird feeders is the solution for one of the biggest problems encountered in urban rat control. Specifically, residents often refuse to stop feeding wild birds when instructed to. Some embodiments of the enticement enclosure 10 can be mounted directly on a fence as well as vertical surfaces, walls, poles, and posts. More specifically, the enticement enclosure 10 may be adapted to modify the fear and avoidance behaviors of wild rat and rodent populations when encountering commercial rat control products. Components of the enticement enclosure 10 may take advantage of studies on the impressive sensory abilities of wild rats and the behavior changes in rats that are triggered by overpopulation.

The enticement enclosure 10 may be configured to be easy to clean and sanitize its components. For example, as discussed elsewhere herein, the cover 20 or a wall panel 56 may be removed easily to facilitating cleaning and other servicing. Regular cleaning of the components of the enticement enclosure 10 may increase continued success in trapping or rodenticide consumption. Periodic deodorizing and/or sanitizing the components of the enticement enclosure 10 to remove blood, feces, and body oils may be facilitated by the design and impermeability of the materials used to construct the enticement enclosure 10. Frequent cleaning of surfaces to remove body secretions, territorial scent markings, blood, fecal droppings, ectoparasites, dog, and cat urine markings, and other factors facilitates a continuing high level of acceptance by rodents. The design of the enticement enclosure makes it easier to avoid unnecessarily disturbing the structure and installed devices during service and maintenance that would trigger a fear avoidance reaction in the targeted species.

Some embodiments of the enticement enclosure 10 attached it to, or incorporated into, a mobile cart with recording devices, wheels, and tamper resistant metal components and securing agents. Such mobile and transportable variations of the enticement enclosure 10 may be useful for targeting contraceptives at high populations, because contraceptives do not have to be continually available to be effective in reducing rodent populations.

Current rodent control industry “best practices” discourage wild bird feeding and keeping chickens in backyards because when wild birds use most feeders, they scatter seeds to the ground surface 44 below. Foraging rats and other rodents are very attracted to these sites by this regular and reoccurring food source. Contrary to the conventional wisdom, this disbursed seed can be used to lure rats to the enticement enclosure 10, which provides them temporary shelter, along with introducing them to traps 164 and/or other components of the pest control system 80 contained in the interior volume 18. In urban areas of the United States, rat over population is usually a neighborhood issue, not caused by a single home or landowner. So, a well-positioned enticement enclosure 10 may readily draw rats from a neighbor's bird feeder 24 and rectify a neighborhood rat problem encouraged by a neighbor who doesn't want to address pest control.

Moreover, individual property owners and concerned organizations now have a viable and economically sound choice between using poison rodenticides and nonlethal methods like contraceptives and live trapping for relocation. Many rat poisons employ anticoagulants that become stored in the rat's liver, and poisoned rats become easy prey. An average owl for example will eat 1000 rats per year. The result is a lot of dead owls Thus, the enticement enclosure 10 may significantly lessen the current, pervasive, and environmentally destructive dependence on toxic rodenticides. Seniors, disabled, and shut-ins, will be overjoyed to continue feeding their wild bird friends, while knowing they have a contraceptive option to participate in a new ecologically safer way to reduce rodent populations their neighborhood.

Employing contraceptives can be especially useful for chicken coop applications. Rodenticides can't be used near chicken coops due to the extreme effect on the chickens. The enticement enclosure can be used with or without modification to utilize the attractiveness of the chicken coops and to divert rodents to the enticement enclosure 10.

Installations in sewers and below sewer grates may utilize the accessory baits 162 and dispensers, along with special access ropes and laddering methods to facilitate rat attraction and entry. Roof units for control of roof rats and squirrels can, but not always, employ modified accessories, such as longer legs 88 and anchor systems, to level and secure the enticement enclosure 10. Tree and roof embodiments may also incorporate aerial pathways, such ropes, pipes, or other connecting structures that may be attractive to roof rats, Rattus rattus.

Many different forms and embodiments are possible without deviating from the spirit and teachings of this disclosure and so this disclosure should not be construed as limited to the example embodiments set forth herein. For example, skilled persons will appreciate that the subject matter of any sentence or paragraph can be combined with subject matter of some or all of the other sentences or paragraphs, except where such combinations are mutually exclusive.

### CONCLUSION

The terms and descriptions used above are set forth by way of illustration and example only and are not meant as limitations. Those skilled in the art will recognize that many variations, enhancements and modifications of the concepts described herein are possible without departing from the underlying principles of the invention.

The scope of the invention should therefore be determined only by the following claims, claims presented in a continuation patent application, and equivalents to the foregoing claims.

1. A method for accelerating acclimation of multiple wild rodents to a pest control system, comprising:
providing a pest enticement enclosure so that it is accessible to multiple wild rodents, wherein the pest enticement enclosure includes an outer wall having an interior surface, an exterior surface, a lower rim, and an interior volume that has space sufficient to house a pest control system above, and spaced apart from, the relative ground surface, and wherein the pest enticement enclosure includes an enclosure horizontal cross-sectional area defined by the interior surface of the outer wall at a suspension elevation position in proximity to the lower rim such that the suspension elevation position is closer to the lower rim than to the cover;
supporting the lower rim of outer wall by employing a support system so that the lower rim is above, and spaced apart from, a relative ground surface to form an entry gap between the lower rim of outer wall and the relative ground surface;
employing a suspension system having one or more horizontally positioned support mechanisms with respective horizontally positioned interior suspension surfaces having a cumulative interior suspension horizontal surface area at the suspension elevation position, wherein a majority of the enclosure horizontal cross-sectional area at the suspension elevation is devoid of the cumulative interior suspension surface area of the horizontally positioned interior suspension surfaces;
supporting the pest control system and/or a lure in the interior volume so that the pest control system and/or a lure is above, and spaced apart from, the relative ground surface and is optionally at or above an elevation of the lower rim;
employing a cover for covering the interior volume within the outer wall; and
employing a ventilation system configured to draw ambient air through the entry gap into the interior volume and through one or more vents positioned elevationally higher than the lower rim.

2. The method of claim 1, wherein one or more of the support mechanisms of the horizontally positioned interior suspension system are connected to the outer wall to support an internal auxiliary feature elevationally at or above the lower rim.

3. The method of claim 1, wherein one or more of the support mechanisms have a vertical cross-sectional profile that is circular.

4. The method of claim 3, wherein at least one of the support mechanisms comprises a rod or wire.

5. The method of claim 1, wherein one or more of the support mechanisms comprise a suspension strip.

6. The method of claim 1, wherein one or more of the support mechanisms comprise at least two supports that are positioned transverse to each other.

7. The method of claim 1, further comprising supplying fresh water to encourage the rodents to make return visits to the pest enticement enclosure.

8. The method of claim 1, further comprising supplying an internal auxiliary feature configured to distribute a contraceptive.

9. The method of claim 1, wherein one or more of the lure, the pest control system, or other an internal feature is supported by the suspension system.

10. The method of claim 1, further comprising dispensing one or more of an antibiotic, an antiviral, or an insecticide from a health-related treatment dispenser, wherein the health-related treatment dispenser comprises one or more of a liquid dispenser or a dust dispenser.

11. The method of claim 1, wherein the entry gap has a height dimension configured to facilitate entry of medium-sized target animals and to slow entry of larger-sized target animals.

12. The method of claim 1, wherein the pest enticement enclosure has size characteristics that are configured to encourage dwell time within the pest enticement enclosure.

13. The method of claim 1, wherein the pest enticement enclosure is configured to reduce stress behavior of target animals.

14. The method of claim 1, wherein the support system is configured to maintain the outer wall in a stationary position, wherein the entry gap comprises a gap entry height that is less than or equal to 2.5 inches (6.35 cm), and wherein the entry gap provides horizontal sight lines from any entry point beneath the lower rim through greater than or equal to 70% of a perimeter of the lower rim.

15. The method of claim 1, wherein the enclosure comprises an enclosure height between the lower rim and an upper exterior surface of the cover that is greater than or equal to 12 inches (30.5 cm) and that is less than or equal to 22 inches (55.9 cm).

16. A pest enticement enclosure for a target animal, wherein the target animal comprises a wild rodent, the pest enticement enclosure comprising:
an outer wall having an interior surface, an exterior surface, and a lower rim;
a support system to directly or indirectly support the lower rim of outer wall above, and spaced apart from, a relative ground surface to form an entry gap between the lower rim of outer wall and the relative ground surface;
a cover for covering an interior volume within the outer wall, wherein the interior volume has space sufficient to house a pest control system above, and spaced apart from, the relative ground surface;
an enclosure horizontal cross-sectional area defined by the interior surface of the outer wall at a suspension elevation position in proximity to the lower rim such that the suspension elevation position is closer to the lower rim than to the cover;
a suspension system having one or more horizontally positioned support mechanisms with respective horizontally positioned interior suspension surfaces having a cumulative interior suspension horizontal surface area at the suspension elevation position, wherein a majority of the enclosure horizontal cross-sectional area at the suspension elevation is devoid of the cumulative interior suspension surface area of the horizontally positioned interior suspension surfaces; and
a ventilation system configured to draw ambient air through the entry gap into the interior volume and through one or more vents positioned elevationally higher than the lower rim.

17. The pest enticement enclosure of claim 16, wherein one or more of the support mechanisms of the horizontally positioned interior suspension system are connected to the outer wall to support an internal auxiliary feature elevationally at or above the lower rim.

18. The pest enticement enclosure of claim 16, wherein one or more of the support mechanisms have a vertical cross-sectional profile that is circular.

19. The pest enticement enclosure of claim 18, wherein at least one of the support mechanisms comprises a rod or wire.

20. The pest enticement enclosure of claim 16, wherein one or more of the support mechanisms comprise a suspension strip.

21. The pest enticement enclosure of claim 16, wherein one or more of the support mechanisms comprise at least two supports that are positioned transverse to each other.

22. The pest enticement enclosure of claim 16, further comprising an internal auxiliary feature comprising a water dispenser.

23. The pest enticement enclosure of claim 16, further comprising an internal auxiliary feature configured to distribute a contraceptive.

24. The pest enticement enclosure of claim 16, wherein one or more of the lure, the pest control system, or other an internal feature is supported by the suspension system.

25. A kit for providing a pest enticement enclosure for accelerating rodent acclimation to a pest control system, the kit comprising:
an outer wall having an interior surface, an exterior surface, and a lower rim;
a support system to directly or indirectly support the lower rim of outer wall above, and spaced apart from, a relative ground surface to form an entry gap between the lower rim of outer wall and the relative ground surface;
a cover for covering an interior volume within the outer wall, wherein the interior volume has space sufficient to house a pest control system above, and spaced apart from, the relative ground surface;
an enclosure horizontal cross-sectional area defined by the interior surface of the outer wall at a suspension elevation position in proximity to the lower rim such that the suspension elevation position is closer to the lower rim than to the cover;
a suspension system having one or more horizontally positioned support mechanisms with respective horizontally positioned interior suspension surfaces having a cumulative interior suspension horizontal surface area at the suspension elevation position, wherein a majority of the enclosure horizontal cross-sectional area at the suspension elevation is devoid of the cumulative interior suspension surface area of the horizontally positioned interior suspension surfaces; and
a ventilation system configured to draw ambient air through the entry gap into the interior volume and through one or more vents positioned elevationally higher than the lower rim.
